(19) United States
(12) Patent Application Publication
(10) Pub. No.: US 2026/0295596 A1
(43) Pub. Date: Oct. 1, 2026

(54) PACKAGING TRAY AND MULTI-FUNCTION MICRO-FLUIDIC ASSEMBLY HAVING SAME

(71) Applicant: VITAL BIOSCIENCES INC., Mississauga (CA)

(72) Inventors: Mate LENGYEL, Mississauga (CA); Fuad MURSHID, Mississauga (CA); Srinivas NADELLA, Toronto (CA); Farnoud KAZEMZADEH, Waterloo (CA)

(73) Assignee: VITAL BIOSCIENCES INC., Mississauga, ON (CA)

(21) Appl. No.: 19/478,081

(22) PCT Filed: Apr. 25, 2024
(86) PCT No.: PCT/IB2024/054056

§ 371 Date: Oct. 23, 2025

Related U.S. Application Data
(60) Provisional application No. 63/498,228, filed on Apr. 25, 2023.

(51) Int. Cl. B01L 9/00

(52) U.S. Cl. CPC B01L 9/527; B01L 2200/025; B01L 2200/0689; B01L 2200/16; B01L 2200/185; B01L 2300/0803; B01L 2300/0851

(57) ABSTRACT

Disclosed are packaging trays, tray assemblies, supporting packs and other devices for use in centrifugal microfluidics. A tray includes a stepped support for stacking a plurality of disc assemblies. The tray also includes retaining members for preventing undesired movement of a disc assembly when it is placed in the tray.

### TECHNICAL FIELD

The present disclosure relates to devices for use in centrifugal microfluidics and methods of making such devices.

### CROSS-REFERENCE TO RELATED APPLICATIONS

The present application claims priority to U.S. Provisional Patent Application 63/498,228 filed Apr. 25, 2023, the entirety in which is incorporated herein by reference.

### BACKGROUND

Currently, 70% of all medical decisions rely on lab based diagnostics but today, the diagnostic process is disjointed from how care is delivered. The primary care system requires patients to travel to external phlebotomy sites to draw blood which is sent to central laboratories via courier, and processed overnight. This means that lab results reach health care professionals long after the patient has left. This friction in care delivery and disease management leads to tremendous waste in the healthcare system:
a. Patients often delay getting lab tests or fail to adhere to lab testing, or subsequent care recommendations
b. The gap in the diagnostic process leads to missed tests, missed diagnosis, a lack of intervention, and ultimately poor outcomes
c. Health care professionals waste time tracing lab orders to patient encounter notes. When intervention is needed, more time is wasted in reaching out to patients and driving subsequent steps in the patient's care pathway.

These problems are even more acute when caring for rural populations or patients belonging to groups facing adverse social-determinants of health, where there are many challenges in ensuring successful follow ups from an initial patient encounter.

Several companies have built point-of-care instruments to bridge this divide. However, these instruments are limited to single types of tests and fail to completely meet the workflow needs of primary care providers for a single system that produces simple, comprehensive, and fast test results. A product to meet these needs is currently under development. It achieves this through a highly automated workflow enabled through the use of centrifugal microfluidics discs.

Accordingly, there remains a need for improved devices and methods in centrifugal microfluidics.

### SUMMARY

The present disclosure addresses these and other needs in the art by providing packaging trays, tray assemblies, supporting packs and other devices for use in centrifugal microfluidics.

In an aspect, the present disclosure provides a tray including a first compartment configured for stacking a plurality of disc assemblies. The first compartment is substantially circular and includes a stepped support. The stepped support includes a plurality of steps along an axial direction of the first compartment and configured for accommodating a corresponding disc assembly in the plurality of disc assemblies that is characterized by a corresponding diameter in a plurality of diameters. In some embodiments, the tray includes at least one axial retaining member formed at or adjacent to each respective step in the plurality of steps and configured for preventing undesired movement of the corresponding disc assembly in the plurality of disc assemblies in the axial direction when the corresponding disc assembly in the plurality of disc assemblies is placed in the first compartment. In some embodiments, the tray includes at least one angular retaining member formed at or adjacent to each respective step in the plurality of steps and configured for preventing undesired rotation of the corresponding disc assembly in the plurality of disc assemblies around an axis of the first compartment when the corresponding disc assembly in the plurality of disc assemblies is placed in the first compartment.

In some embodiments, the plurality of steps is configured such that adjacent disc assemblies in the plurality of disc assemblies are spaced apart from each other along the axial direction of the first compartment when they are placed in the first compartment.

In some embodiments, the plurality of steps includes two, three, four, five or more steps.

In some embodiments, the plurality of steps includes a first step at a first level and configured for accommodating a first disc assembly, and a second step at a second level higher than the first level and configured for accommodating a second disc assembly larger than the first disc assembly. In some such embodiments, the plurality of steps further includes a third step at a third level higher than the second level and configured for accommodating a third disc assembly larger than the second disc assembly.

In some embodiments, the plurality of disc assemblies includes a disc assembly configured for conducting hematology test, a disc assembly configured for conducting clinical chemistry tests, a disc assembly configured for conducting immunoassay tests, or any combination thereof. In some such embodiments, the disc assembly configured for conducting the immunoassay tests is larger than the disc assembly configured for conducting the clinical chemistry tests, which is larger than the disc assembly configured for conducting the hematology test.

In some embodiments, the at least one axial retaining members formed at or adjacent to different steps in the plurality of steps are circumferentially staggered with respect to each other.

In some embodiments, the at least one axial retaining member formed at each respective step in the plurality of steps includes two, three, four or more axial retaining members circumferentially spaced apart from each other.

In some embodiments, each of the at least one angular retaining member formed at or adjacent to each respective step in the plurality of steps is configured to engage with a notch formed at an outer perimeter of the corresponding disc assembly in the plurality of disc assemblies.

In some embodiments, the at least one angular retaining member formed at or adjacent to each respective step in the plurality of steps consists of a single angular retaining member.

In some embodiments, the first compartment further includes a bottom wall, and a central positioning feature formed at the bottom wall of the first compartment and configured for engaging with a locating feature of an instrument to prevent lateral and angular movement of the tray when the tray is placed in the instrument. In some such embodiments, the central positioning feature has a cross section of a substantially triangular shape.

In some embodiments, a support feature is formed at the bottom wall of the first compartment and leveled with the central positioning feature and a bottom wall of a second compartment to facilitate placement of the tray on a surface.

In some embodiments, the first compartment includes a designated area on an inner surface of the bottom wall for placing one or more test strips.

In some embodiments, the tray further includes a second compartment configured for accommodating a desiccant and a conduit connecting the second compartment with the first compartment.

In some embodiments, the tray further includes a third compartment configured for accommodating a vial for one or more external processes from the plurality of disc assemblies.

In some embodiments, the tray further includes a flange formed with the first compartment, the second compartment, and/or the third compartment and configured for engaging with a rail of an instrument. In some such embodiments, the flange includes a chamfered edge to prevent misplacement of the flange in the instrument.

In some embodiments, the tray further includes: a plurality of sealing ribs formed at an upper surface of the flange and configured for engaging with a sealing film, at least one gripping member formed at the flange and configured for facilitating easy grip of the tray, a plurality of structural ribs formed at the flange and/or the stepped support of the first compartment, and configured for enhancing a strength of the tray, at least one guiding member formed at the flange and configured for indicating a proper orientation of the tray, a feedback member formed at the flange and configured for providing a feedback regarding placement of the tray, a fourth compartment for accommodating a reagent pack, a pipette pack or both, or any combination thereof.

In some embodiments, the present disclosure provides a reagent pack including a plurality of wells. Each respective well in the plurality of wells including a corresponding opening, a corresponding closed bottom, and a corresponding circumferential side wall between the corresponding opening and closed bottom and formed in a corresponding pre-defined profile. An angle of the corresponding pre-defined profile relative to an axis of the respective well increases from the corresponding opening to the corresponding closed bottom of the respective well.

In another embodiment, there is a tray including a first compartment configured for stacking a plurality of disc assemblies, wherein the first compartment is substantially circular and includes a stepped support comprising a plurality of steps along an axial direction of the first compartment and configured for accommodating a corresponding disc assembly in the plurality of disc assemblies that is characterized by a corresponding diameter in a plurality of diameters.

The first compartment further includes at least one axial retaining member formed at or adjacent to each respective step in the plurality of steps and configured for preventing the corresponding disc assembly in the plurality of disc assemblies from moving in the axial direction when the corresponding disc assembly in the plurality of disc assemblies is placed in the first compartment. The first compartment further includes at least one angular retaining member formed at or adjacent to each respective step in the plurality of steps and configured for preventing the corresponding disc assembly in the plurality of disc assemblies from rotating around an axis of the first compartment when the corresponding disc assembly in the plurality of disc assemblies is placed in the first compartment. The tray further includes a second compartment configured for accommodating a desiccant, a third compartment configured for accommodating a vial for one or more external processes from the plurality of disc assemblies, a reagent pack including a plurality of wells, each respective well in the plurality of wells including a corresponding opening, a corresponding closed bottom, and a corresponding circumferential side wall between the corresponding opening and closed bottom and formed in a corresponding pre-defined profile, wherein an angle of the corresponding pre-defined profile relative to an axis of the respective well increases from the corresponding opening to the corresponding closed bottom of the respective well. The tray further includes a fourth compartment for accommodating the reagent pack, a pipette pack or both, or any combination thereof and one or more test strips including reaction pads that perform colorimetric assays on samples such as urine, whole blood, plasma, serum, or other processed samples.

The devices, systems and methods of the present disclosure have other features and advantages that will be apparent from, or are set forth in more detail in, the accompanying drawings, which are incorporated herein, and the following Detailed Description, which together serve to explain certain principles of exemplary embodiments of the present disclosure.

### BRIEF DESCRIPTION OF DRAWINGS

The accompanying drawings, which are incorporated into and constitute a part of this specification, illustrate one or more exemplary embodiments of the present disclosure and, together with the Detailed Description, serve to explain the principles and implementations of exemplary embodiments of the invention. The accompanying drawings are not necessarily to scale. The specific design features of the present invention as disclosed herein, including, for example, specific dimensions, orientations, locations, and shapes will be determined in part by the particular intended application and use environment. In addition, the components illustrated in the figures are combinable in any useful number and combination.

In the drawings:

FIG. 1 illustrates in an exploded view an exemplary tray assembly in accordance with some exemplary embodiments of the present disclosure;

FIGS. 2A-2E illustrates in top views an exemplary tray in accordance with some embodiments of the present disclosure;

FIG. 3A-3J collectively illustrate an exemplary process for making an exemplary tray assembly in accordance with some embodiments of the present disclosure;

FIG. 4A illustrates in a perspective view an exemplary opened support kit assembly and an exemplary opened tray assembly prepared for insertion into an exemplary instrument drawer in accordance with some embodiments of the present disclosure;

FIG. 4B illustrates in a perspective view the exemplary opened support kit assembly and the exemplary opened tray assembly of FIG. 4A inserted into the exemplary instrument drawer in accordance with some embodiments of the present disclosure;

FIG. 5 illustrates in a perspective view an engagement of an exemplary disc assembly with an exemplary tray in accordance with some embodiments of the present disclosure;

FIG. 6 illustrates in a perspective view transfer of a sample to a test strip on an exemplary tray in accordance with some embodiments of the present disclosure;

FIG. 7 illustrates in a perspective view return of used components to an exemplary opened support kit assembly and an exemplary opened tray assembly in accordance with some embodiments of the present disclosure;

FIG. 8 illustrates in an exploded view an exemplary support pack assembly in accordance with some embodiments of the present disclosure;

FIG. 9A illustrates in top, side and bottom views an exemplary reagent pack in accordance with some embodiments of the present disclosure;

FIGS. 9B-9D illustrate in perspective views an exemplary reagent pack in accordance with some embodiments of the present disclosure;

FIGS. 9E-9J illustrate an exemplary reagent pack in accordance with some embodiments of the present disclosure;

FIGS. 10A-10H collectively illustrate an exemplary process for making an exemplary support pack in accordance with some embodiments of the present disclosure;

FIG. 11A illustrates in an exploded view an exemplary integrated kit in accordance with some embodiments of the present disclosure;

FIG. 11B illustrates in a perspective view of the exemplary integrated kit of FIG. 11A.

FIG. 12A illustrates in a perspective view an exemplary unibody support pack in accordance with some embodiments of the present disclosure;

FIGS. 12B and 12C illustrate the exemplary unibody support pack of FIG. 12 A when folded and unfolded in accordance with some embodiments of the present disclosure;

FIG. 13A illustrates in a perspective view top view a second embodiment of the tray in accordance with some aspects of the present disclosure;

FIG. 13B illustrates in a top view the exemplary tray of FIG. 13A;

FIG. 13C illustrates in a bottom view the exemplary tray of FIG. 13A; and

FIG. 14 illustrates in a top view a third embodiment of the tray in accordance with some aspects of the present disclosure.

### DETAILED DESCRIPTION

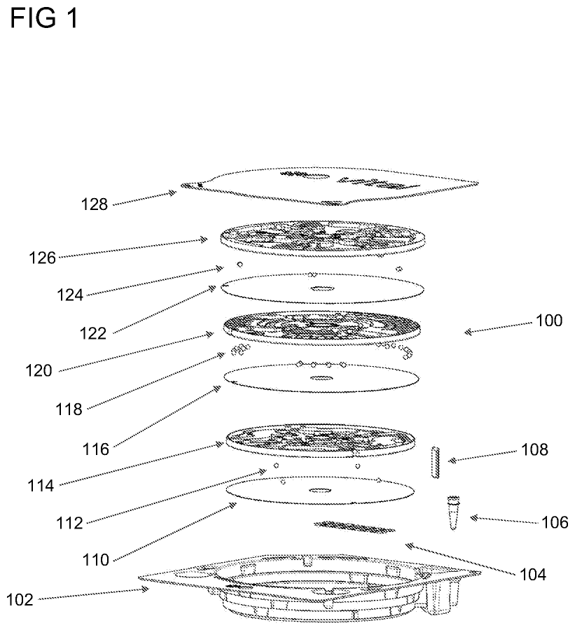

Referring now to the drawings, like reference numerals indicate like elements throughout. FIG. 1 illustrates an exemplary tray assembly 100 in accordance with some embodiments of the present disclosure. Tray assembly 100 includes tray 102, test strips 104, external vial 106, desiccant 108, first capping layer 110, first lyophilized reagent beads 112, first disc 114, second capping layer 116, second lyophilized reagent beads 118, second disc 120, third capping layer 122, third lyophilized reagent beads 124, third disc 126, and tray sealing film 128. In some embodiments, first capping layer 110, first lyophilized reagent beads 112, and first disc 114 are sub assembled forming first disc assembly 109. In some embodiments, second capping layer 116, second lyophilized reagent beads 118, and second disc 120 are sub assembled forming second disc assembly 115. In some embodiments, third capping layer 122, third lyophilized reagent beads 124, and third disc 126 are sub assembled forming third disc assembly 121.

While FIG. 1 illustrates that tray assembly 100 includes three disc assemblies, it should be noted that this is by way of illustration and the present invention is not limited thereof. For instance, in some embodiments, tray assembly 100 can include a single disc assembly (e.g., any one of first disc assembly 109, second disc assembly 115 and third disc assembly 121) or two disc assemblies (e.g., any two of first disc assembly 109, second disc assembly 115 and third disc assembly 121). In some embodiments, tray assembly 100 may be configured to have more than three disc assemblies. Moreover, where FIG. 1 illustrates that tray assembly 100 includes test strips 104, external vial 106 and desiccant 108, it should be noted that tray assembly 100 can, but does not have to include test strips 104, external vial 106 and desiccant 108. In other words, test strips 104, external vial 106 and desiccant 108 are optional or additional components. Further, in some embodiments, tray assembly 100 may include other alternative, optional or additional components that are not illustrated in FIG. 1. In addition, reagents can take various forms and can be dry or wet. For instance, reagents may take many other forms different than reagent beads. Reagents may be dispensed and dried in a disc or on a capping layer.

As illustrated in subsequent figures, in some embodiments, one or more test strips 104 are inserted into tray 102. In some embodiments, external vial 106 can include additional lyophilized reagent beads, and can be sealed, for instance, with foil, which can be punctured while filling external vial 106 with liquid and mixing. In some embodiments, desiccant 108 can be placed in tray 102, and provides desiccation for test strips 104, first lyophilized reagent beads 112, second lyophilized reagent beads 118, third lyophilized reagent beads 124, and additional lyophilized reagent beads in external vial 106. In some embodiments, first disc assembly 109, second disc assembly 115, and/or third disc assembly 121 are clipped into tray 102, as illustrated in subsequent figures. After placing one or more test strips 104, external vial 106, desiccant 108, first disc assembly 109, second disc assembly 115, third disc assembly 121, and additional lyo beads into tray 102, it is sealed with tray sealing film 128.

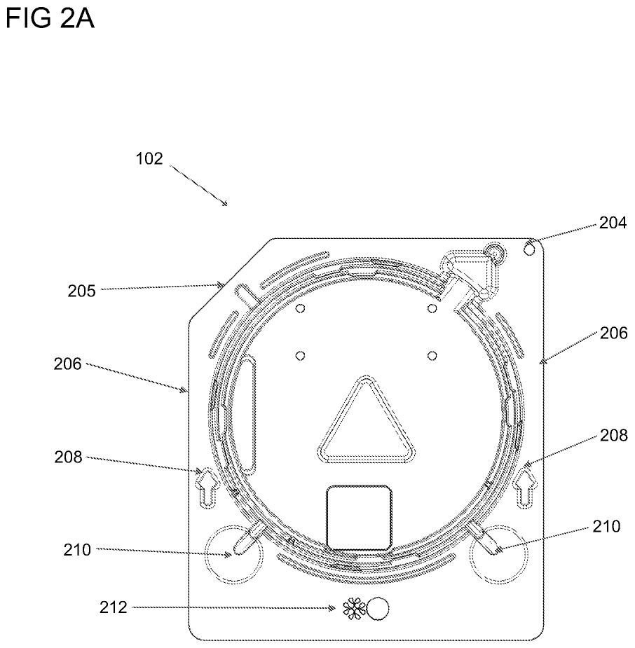

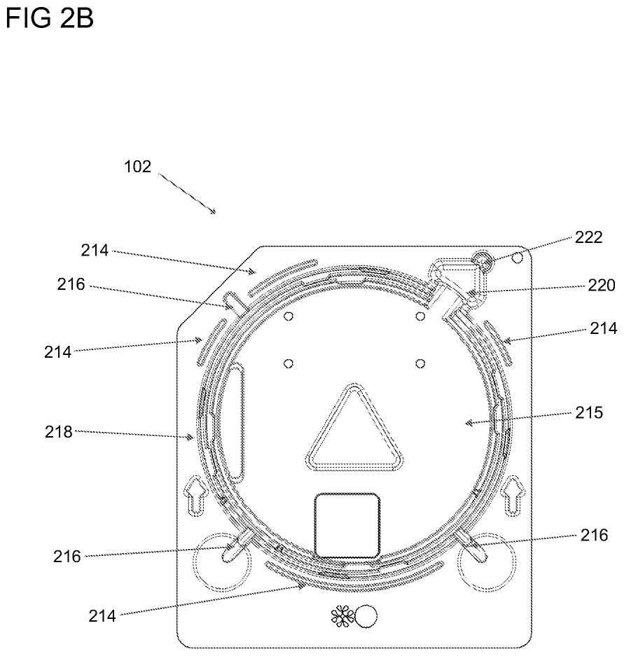

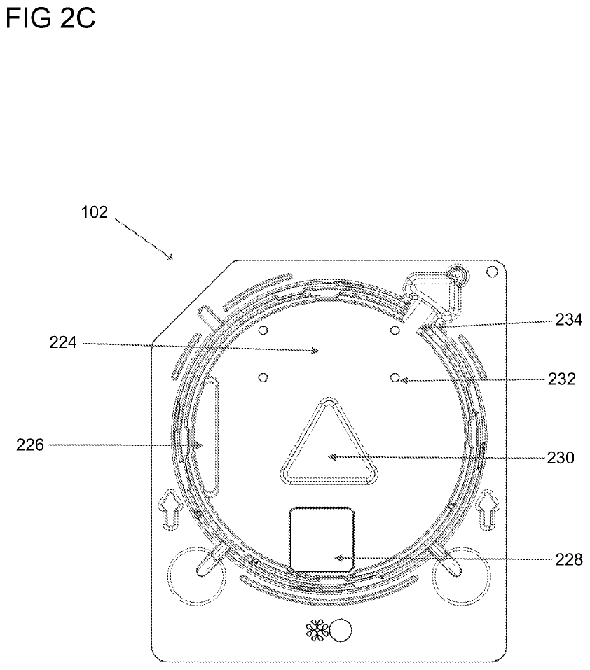

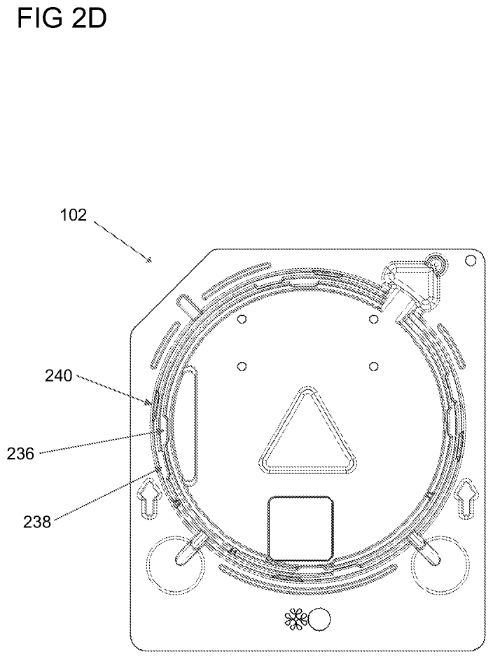

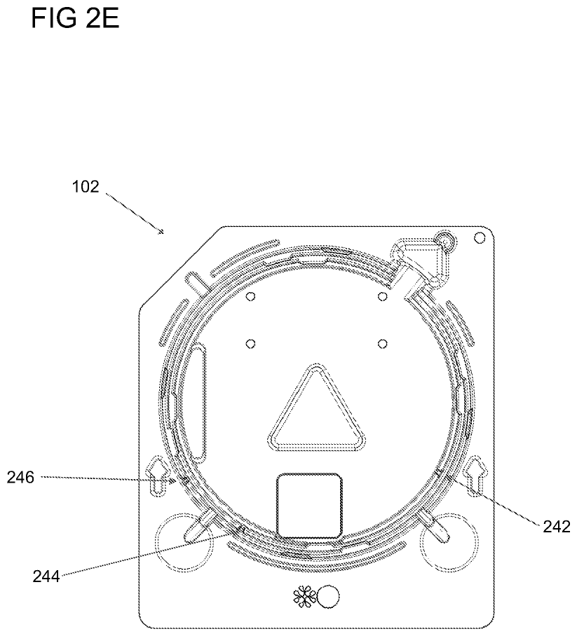

FIG. 2A illustrates some additional or optional features of tray 102 in accordance with some embodiments of the present disclosure. In some embodiments, tray 102 includes a feedback member such as tactile feedback dimple 204, one or more positioning flanges 206, one or more guiding members such as guide arrows 208, one or more gripping members such as thumb grips 210, identifying logo 212, tray chamfer 205, or any combination thereof. In some embodiments, tactile feedback dimple 204 provides tactile feedback to the user while tray 102 is inserted into an instrument, as illustrated in subsequent figures. When tray 102 is fully inserted, it clicks into place as tactile feedback dimple 204 drops into a matching recess in the instrument. In some embodiments, one or more positioning flanges 206 align tray 102, e.g., left to right, as tray 102 is inserted into an instrument. Sufficient clearance is left on each side to allow easy insertion of tray 102 into the instrument. In some embodiments, tray chamfer 205, guide arrows 208, and/or identifying logo 212 illustrate proper insertion orientation for the user, while one or more thumb grips 210 provide clearance for removal of previously illustrated tray sealing film 128.

FIG. 2B illustrates some additional or optional features of tray 102 in accordance with some embodiments of the present disclosure. In some embodiments, tray 102 includes a first compartment 215 (e.g., the space surrounded by stepped disc support 218) configured for accommodating one or more disc assemblies such as first disc assembly 109, second disc assembly 115, third disc assembly 121 or any combination thereof. In some embodiments, tray 102 includes one or more additional compartments, such as a second compartment (e.g., desiccant pocket 220) and/or a third compartment (external vial pocket 222), configured for accommodating one or more additional components. In some embodiments, tray 102 includes other additional or optional features.

For instance, in some embodiments, tray 102 includes one or more sealing ribs 214, one or more structural ribs 216, stepped disc support 218, desiccant pocket 220, external vial pocket 222, or any combination thereof. In some embodiments, one or more sealing ribs 214 provide surfaces in tray 102 for bonding to previously illustrated tray sealing film 128. The total surface area of sealing ribs 214 can be increased or decreased to increase or decrease bond strength between tray 102 and tray sealing film 128, making it more difficult or less difficult to remove tray sealing film 128 from tray 102. In some embodiments, one or more structural ribs 216 can be added at various locations on tray 102 to increase flexural strength of tray 102. In some embodiments, desiccant pocket 220 houses previously illustrated desiccant 108, providing a clear path for moisture to migrate throughout tray 102. In some embodiments, external vial pocket 222 can house previously illustrated external vial 106. External vial 106 can house additional lyophilized reagent beads, and provides an off disc means for reconstituting additional lyophilized reagent beads. In some embodiments, stepped disc support 218 provides a unique position for each disc inserted into tray 102. When inserted into tray 102, first disc assembly 109 sits on the bottom step of stepped disc support 218, second disc assembly 115 sits on the middle step of stepped disc support 218, and third disc assembly 121 sits on the top step of stepped disc support 218. This provides precise positioning of first disc assembly 109, second disc assembly 115, and third disc assembly 121 in tray 102.

While it is illustrated that stepped disc support 218 include three steps, it should be noted that it is by way of example and it is non-limiting. Stepped disc support 218 can be configured to include any suitable number of steps, such as one, two, three, four, five, or more than five steps. In some embodiments, stepped disc support 218 is configured for vertically stacking multiple disc assemblies, where adjacent disc assemblies are spaced apart from each other along the axial direction of the first compartment 215 when they are placed in the first compartment 215 (e.g., when seated on the steps of stepped disc support 218). It should be noted that stepped disc support 218 having multiple steps can but do not have to hold multiple disc assemblies. For instance, stepped disc support 218 having multiple steps can be used to hold a single disc assembly.

FIG. 2C illustrates some additional or optional features of tray 102 in accordance with some embodiments of the present disclosure. In some embodiments, tray 102 includes test strip area 224, support feature 226, code placement feature 228, central positioning feature 230, test strip positioning marks 232, desiccant conduit 234, or any combination thereof. In some embodiments, test strip area 224 provides a region in tray 102 for placing previously illustrated one or more test strips 104. Positioning one or more test strips 104 in test strip area 224 allows easy access after first disc assembly 109, second disc assembly 115, and third disc assembly 121 have been removed from tray 102. Sample can be applied to one or more test strips 104, and the color of one or more test strips 104 can be read by imaging means in the instrument. In some embodiments, one or more test strips 104 can be adhesively fixed to test strip area 224, or can be clipped into recesses in test strip area 224. In some embodiments, test strip positioning marks 232 can be used in the manufacturing of tray assembly 100, and can also be used by the instrument when inspecting one or more test strips 104. In some embodiments, support feature 226 can be included in tray 102 to provide balance when tray 102 is placed on a surface before inserting into the instrument. For instance, in some embodiments, support feature 226 is leveled with central positioning feature 230 and/or a bottom of a second compartment to facilitate placement of the tray on a surface

In some embodiments, code placement feature 228 allows for placement of machine readable information onto tray 102, such as calibration information, test menu, expiration date, etc. In some embodiments, central positioning feature 230 engages with pockets (e.g., a locating feature 401) in the instrument to provide precise positioning of tray 102 in the instrument (e.g., preventing lateral and angular movement of the tray when the tray is placed in the instrument). In some embodiments, the central positioning feature has a cross section of a substantially triangular shape. In some embodiments, desiccant conduit 234 provides a clear path between first disc assembly 109, second disc assembly 115, third disc assembly 121, test strips 104, and desiccant 108, allowing moisture to be absorbed by desiccant 108.

FIG. 2D illustrates some additional or optional features of tray 102 in accordance with some embodiments of the present disclosure. In some embodiments, tray 102 includes at least one axial retaining member, such as first disc retaining feature 236, second disc retaining feature 238, or third disc retaining feature 240, formed at or adjacent to each step (e.g., the bottom, middle, or top step) and configured for preventing undesired movement of the corresponding disc assembly (e.g., first disc assembly 109, second disc assembly 115, or third disc assembly 121) in the axial direction when the corresponding disc assembly is placed in the compartment (e.g., when placed on the step of stepped disc support 218). In some embodiments, the at least one axial retaining members formed at or adjacent to different steps are circumferentially staggered with respect to each other. In some embodiments, the at least one axial retaining member formed at each step includes two, three, four or more axial retaining members circumferentially spaced apart from each other.

As a non-limiting example, it is illustrated that tray 102 includes one or more first disc retaining features 236, one or more second disc retaining features 238, and one or more third disc retaining features 240. As first disc assembly 109 is pressed into tray 102 during assembly, the outer perimeter of first disc assembly 109 makes contact with one or more first disc retaining features 236, providing a slight interference fit which will retain first disc assembly 109 in tray 102. The interference fit is not excessive, so that first disc assembly 109 can be easily removed by the instrument in subsequent steps. As second disc assembly 115 is pressed into tray 102 during assembly, the outer perimeter of second disc assembly 115 makes contact with one or more second disc retaining features 238, providing a slight interference fit which will retain second disc assembly 115 in tray 102. As third disc assembly 121 is pressed into tray 102 during assembly, the outer perimeter of third disc assembly 121 makes contact with one or more third disc retaining features 240, providing a slight interference fit which will retain third disc assembly 121 in tray 102. First disc assembly 109 has the smallest diameter of the discs, and is inserted into tray 102 first during manufacturing. Second disc assembly 115 has the next largest diameter and is inserted into tray 102 after first disc assembly 109. Third disc assembly 121 has the largest diameter of the discs, and is inserted into tray 102 after second disc assembly 115.

Disc retaining features secure the discs during transport, provide precise positioning in tray 102, and allow removal of the discs from tray 102 by the instrument at appropriate times.

FIG. 2E illustrates some additional or optional features of tray 102 in accordance with some embodiments of the present disclosure. In some embodiments, tray 102 includes at least one angular retaining member, such as first angular lock 242, second angular lock 244, or third angular lock 246, formed at or adjacent to each step (e.g., the bottom, middle, or top step) and configured for preventing undesired rotation of the corresponding disc assembly (e.g., first disc assembly 109, second disc assembly 115, or third disc assembly 121) around an axis of the compartment when the corresponding disc assembly is placed in the compartment (e.g., when placed on the step of stepped disc support 218). In some embodiments, the at least one angular retaining member formed at one or each step consists of a single angular retaining member.

As a non-limiting example, it is illustrated that tray 102 includes first angular lock 242, second angular lock 244, and third angular lock 246. In some embodiments, first angular lock 242 is a molded feature in tray 102 which engages a notch in the side of first disc assembly 109, providing precise rotational position of first disc assembly 109 in tray 102. As illustrated in subsequent figures, it is important for discs to be positioned in tray 102 with precise positioning in the x, y, and z axis, and rotationally. In some embodiments, second angular lock 244 is a molded feature in tray 102 which engages a notch in the side of second disc assembly 115, providing precise rotational position of second disc assembly 115 in tray 102. In some embodiments, third angular lock 246 is a molded feature in tray 102 which engages a notch in the side of third disc assembly 121, providing precise rotational position of third disc assembly 121 in tray 102. An important function of tray 102 is to precisely position first disc assembly 109, second disc assembly 115, and third disc assembly 121 for later processing by the instrument.

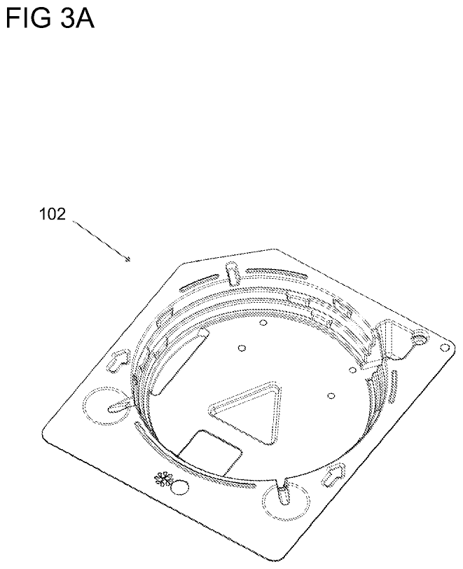

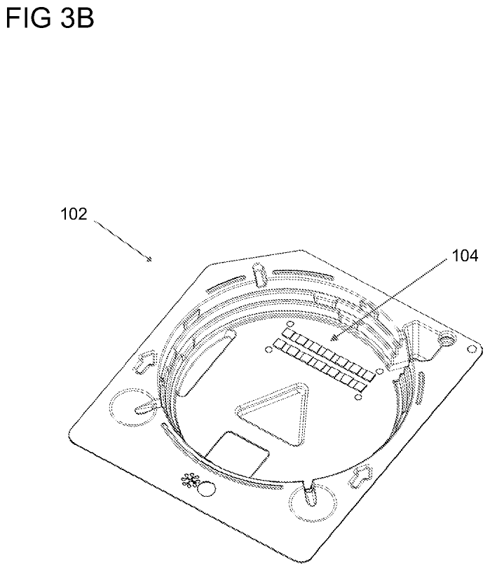

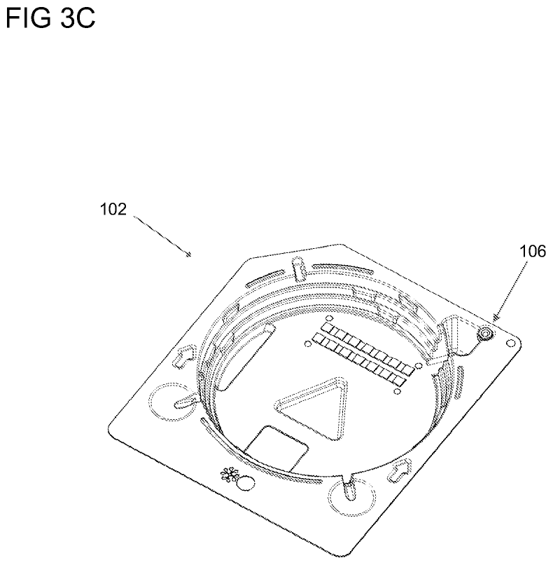

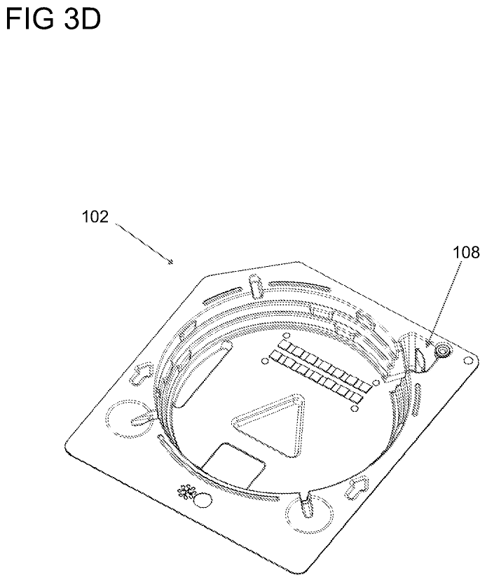

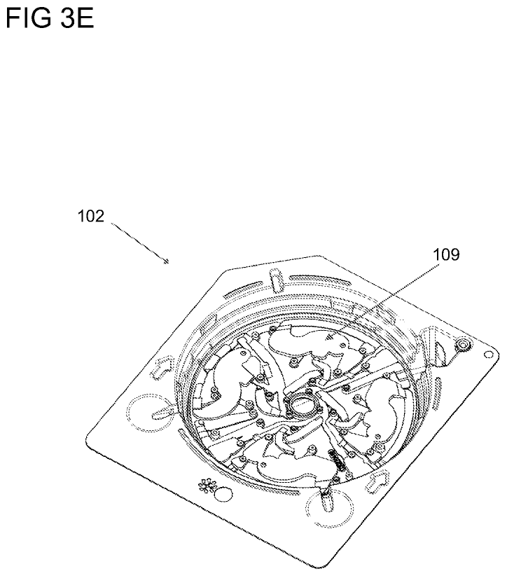

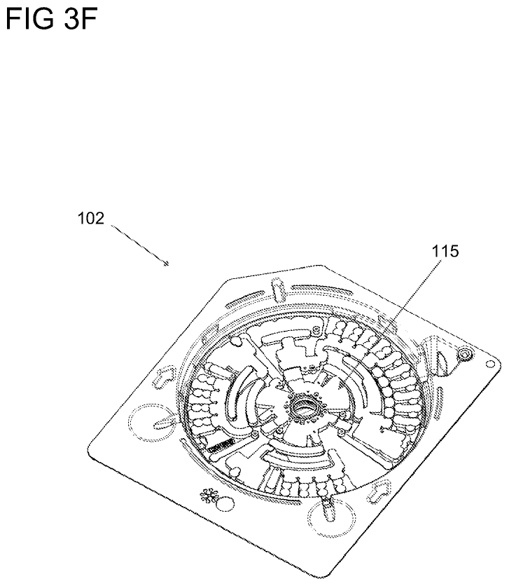

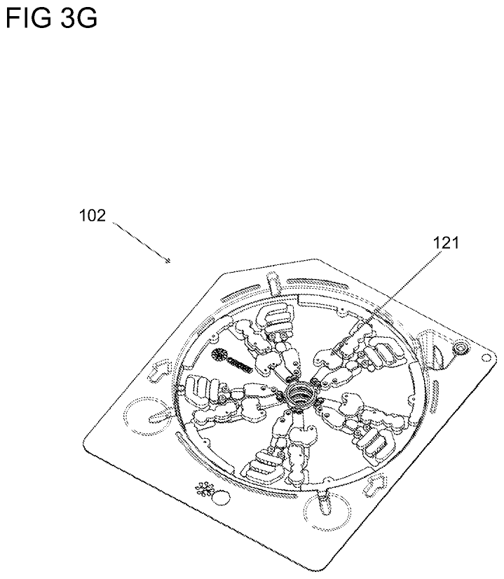

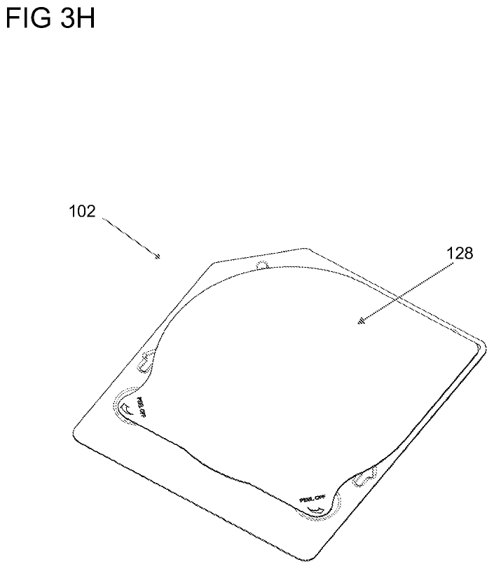

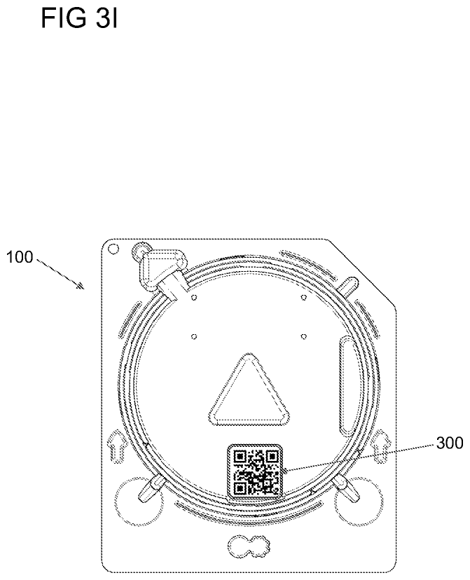

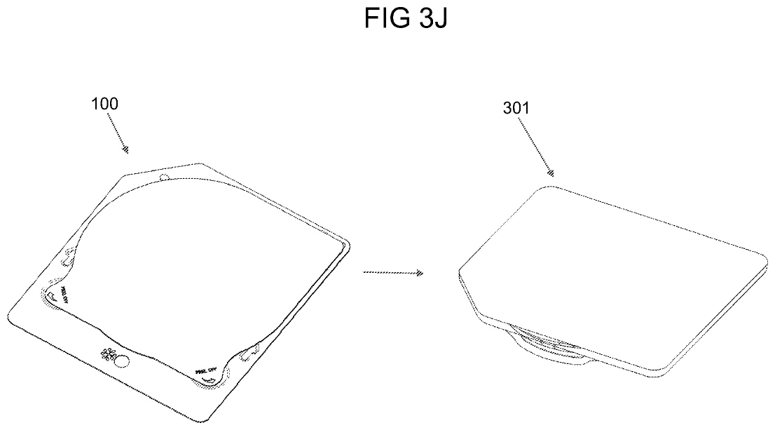

FIGS. 3A-3J illustrate step-by-step assembly of tray assembly 100 in accordance with some embodiments of the present disclosure.

FIG. 3A illustrates that tray 102 is empty, and is ready to load with various components.

In FIG. 3B, one or more test strips 104 are placed in tray 102 in accordance with some embodiments of the present disclosure. As mentioned previously, one or more test strips 104 can be bonded to tray 102 with a variety of ways, such as adhesive bonding, or interference bonding such as clipping into a pocket. One or more test strips 104 can perform a wide variety of colorimetric assays, on samples such as urine, whole blood, plasma, serum, or other processed samples. It should be noted that placing one or more test strips 104 in tray 102 is an optional or additional step. Depending on the application, tray assembly 100 may or may not include one or more test strips 104.

In FIG. 3C, external vial 106 is placed in tray 102 in accordance with some embodiments of the present disclosure. External vial 106 provides an additional, off-disc chamber for processing samples. Sample and/or diluent can be added to and mixed in external vial 106. External vial 106 can contain reagents, such as liquids and/or lyophilized reagent beads. Although a single external vial 106 is illustrated in tray 102, additional external vials can be added in other locations in tray 102. External vial 106 can be sealed with a film or foil or the like, which can be pierced using pipette tips by the instrument. Solutions in external vial 106 can be transferred back into first disc assembly 109, second disc assembly 115, and/or third disc assembly 121 for further processing and analysis. It should be noted that placing external vial 106 in tray 102 is an optional or additional step. Depending on the application, tray assembly 100 may or may not include external vial 106.

In FIG. 3D, desiccant 108 is placed in tray 102 in accordance with some embodiments of the present disclosure. Desiccant 108 controls the humidity level in tray 102, and can include a variety of desiccant materials such as silica gel, molecular sieve, etc. Desiccant 108 is typically packaged in a material which transmits water vapor, such as Tyvek. The function of desiccant 108 is to keep lyophilized reagent beads and one or more test strips 104 dry, prolonging their shelf life. It should be noted that placing desiccant 108 in tray 102 is an optional or additional step. In some embodiments, tray assembly 100 may or may not include desiccant 108.

In FIG. 3E, first disc assembly 109 is placed in tray 102 in accordance with some embodiments of the present disclosure. First disc assembly 109 is inserted into tray 102 until first disc assembly 109 sits upon the bottom step of stepped disc support 218, and is retained in tray 102 by an interference fit with first disc retaining features 236. The bottom step of stepped disc support 218 and the interference fit with first disc retaining features 236 provide precise positioning of first disc assembly 109 in tray 102, and provides secure packaging for storage and shipping.

In FIG. 3F, second disc assembly 115 is placed in tray 102 in accordance with some embodiments of the present disclosure. Second disc assembly 115 is inserted into tray 102 until second disc assembly 115 sits upon the middle step of stepped disc support 218, and is retained in tray 102 by an interference fit with second disc retaining features 238. The middle step of stepped disc support 218 and the interference fit with second disc retaining features 238 provide precise positioning of second disc assembly 115 in tray 102, and provides secure packaging for storage and shipping.

In FIG. 3G, third disc assembly 121 is placed in tray 102 in accordance with some embodiments of the present disclosure. Third disc assembly 121 is inserted into tray 102 until third disc assembly 121 sits upon the top step of stepped disc support 218, and is retained in tray 102 by an interference fit with third disc retaining features 240. The bottom step of stepped disc support 218 and the interference fit with third disc retaining features 240 provide precise positioning of third disc assembly 121 in tray 102, and provides secure packaging for storage and shipping.

While FIGS. 3E-3G illustrate placement of three discs in tray 102, it should be noted that it is by way of example and is non-limiting. In some embodiments, tray assembly 100 is assembled with one disc (e.g., any one of first disc assembly 109, second disc assembly 115 and third disc assembly 121). In some embodiments, tray assembly 100 is assembled with two discs (e.g., any two of first disc assembly 109, second disc assembly 115 and third disc assembly 121).

In FIG. 3H, tray sealing film 128 is attached to tray 102, sealing tray 102 and protecting its contents from contamination in accordance with some embodiments of the present disclosure. Tray sealing film 128 can be made out of a material that is transmissive to moisture, such as Tyvek, or it can be a barrier to moisture, such as a laminate which includes aluminum foil. In some embodiments, tray sealing film 128 includes tabs at its corners which can be used when removing tray sealing film 128 from tray 102 prior to use.

In FIG. 3I, code 300 is printed onto the back side of tray assembly 100 in accordance with some embodiments of the present disclosure. Code 300 can provide machine and/or human readable information which may include lot specific data, calibration information, expiration date, assay types, etc. If code 300 includes machine readable data, code 300 can be imaged by the instrument prior to or after insertion of tray assembly 100 into the instrument. It should be noted that printing code 300 on tray 102 is an optional or additional step. In some embodiments, tray assembly 100 may or may not include code 300 printed on tray 102.

In FIG. 3J, tray assembly 100 is placed in foil pouch 301, and sealed in accordance with some embodiments of the present disclosure. Foil pouch 301 can be made out of a variety of materials, such as foil laminates, sputtered films, and/or barrier polymers. Foil pouch 301 provides a barrier to moisture vapor transmission, and to light. Materials with low moisture vapor transmission are particularly desirable. Any moisture that migrates across foil pouch 301 is absorbed by desiccant 108, to protect first lyophilized reagent beads 112, second lyophilized reagent beads 118, third lyophilized reagent beads 124, and lyophilized reagent beads which may be contained in external vial 106. It should be noted that placing tray assembly 100 in foil pouch 301 is an optional or additional step. In some embodiments, tray assembly 100 may or may not be placed in foil pouch 301. In some embodiments, tray assembly 100 may be placed in an alternative pouch or the like.

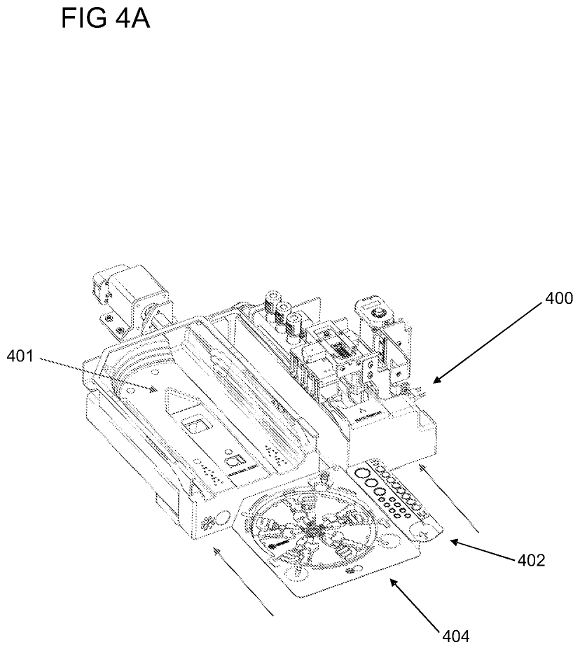

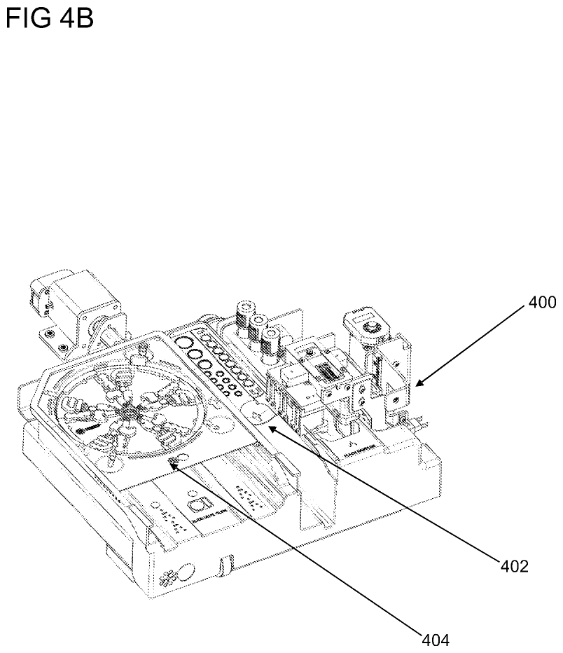

In FIG. 4A, opened support kit assembly 402 and opened tray assembly 404 are prepared for insertion into instrument drawer 400. Prior to insertion, sealing films are removed from opened support kit assembly 402 and opened tray assembly 404, which allows machine access to the contents of opened support kit assembly 402 and opened tray assembly 404.

In FIG. 4B, opened support kit assembly 402 and opened tray assembly 404 are inserted into instrument drawer 400 in accordance with some embodiments of the present disclosure. Areas in the proximal ends of opened support kit assembly 402 and opened tray assembly 404 provide grips for handling the assemblies, while regions on the left and right edges of the assemblies are aligned using guides in the drawer. Upon complete insertion, features on opened support kit assembly 402 and opened tray assembly 404 provide tactile feedback as to complete insertion. Once opened support kit assembly 402 and opened tray assembly 404 are completely inserted, they are precisely positioned in all directions.

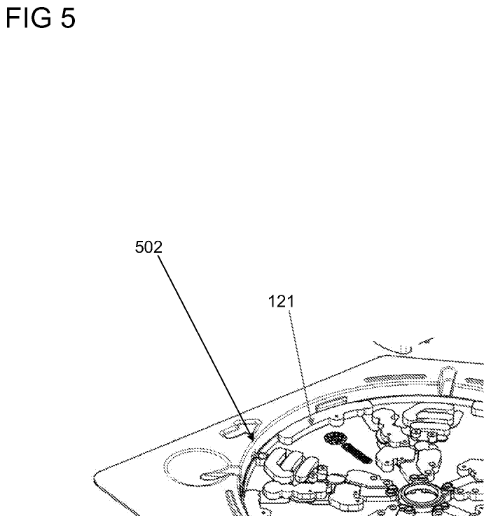

In some embodiments, each angular retaining member (e.g., first angular lock 242, second angular lock 244, or third angular lock 246) formed at each step (e.g., the bottom, middle, or top step) is configured to engage with a notch formed at an outer perimeter of a corresponding disc assembly (e.g., first disc assembly 109, second disc assembly 115, or third disc assembly 121). As a non-limiting example, FIG. 5 illustrates that third disc notch 502 of third disc assembly 121 is engaged with third angular lock 246, providing precise angular position of third disc assembly 121. Precise angular position is important in embodiments where gripper assembly 506 cannot rotate third disc assembly 121.

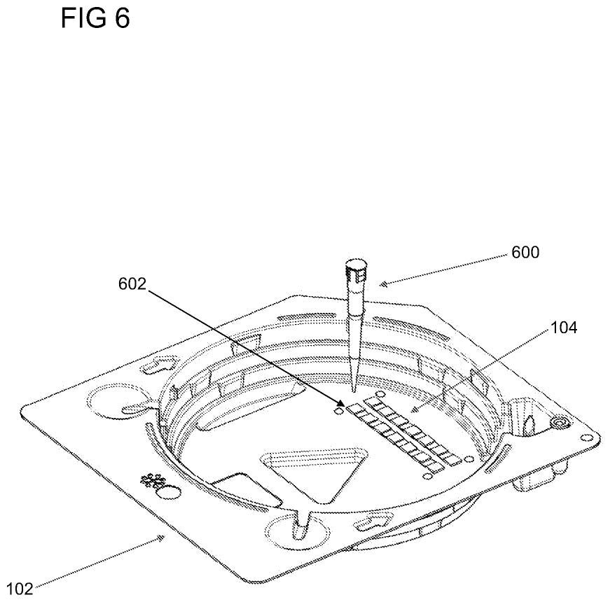

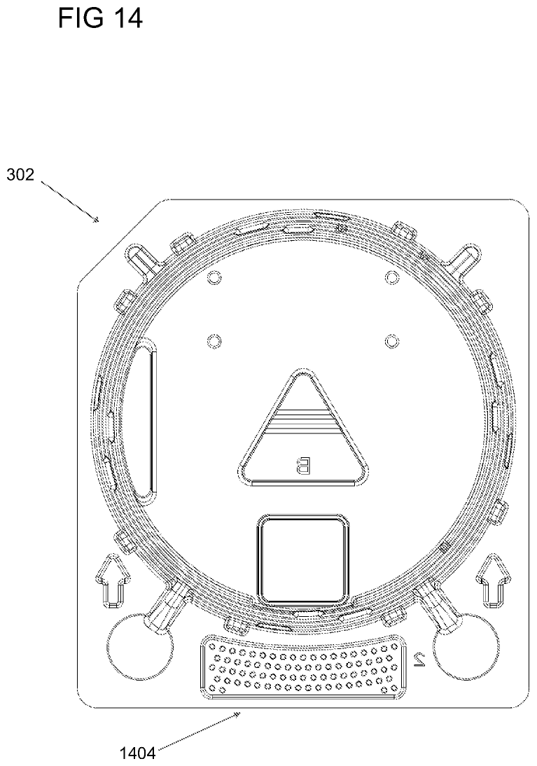

In FIG. 6, sample is transferred by the instrument onto test strips 104 in accordance with some embodiments of the present disclosure. Once first disc assembly 109, second disc assembly 115, and third disc assembly 121 have been removed from tray 102 by the instrument, one or more test strips 104 are exposed. At this point, robotic pipette 600 can apply an aliquot of sample onto reaction pads 602, one pad at a time. A small amount of sample can be applied to each pad, on the order of microliters in volume. As a non-limiting example, in FIGS. 6, 14 discreet reaction pads are illustrated, each of which can perform a different assay. Volume is controlled so that sample stays within each discreet reaction pad. After waiting a predetermined amount of time, reaction pads 602 can be imaged by the instrument, correlating color to analyte concentration. In this way, additional assays and additional sample types can be analyzed in addition to those contained in first disc assembly 109, second disc assembly 115, and third disc assembly 121.

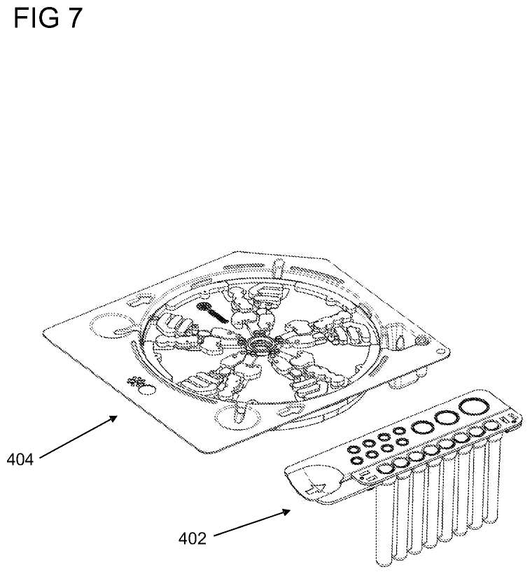

In some embodiments, upon completion of testing, used components are returned to opened support kit assembly 402 and opened tray assembly 404, as illustrated in FIG. 7. Opened support kit assembly 402 and opened tray assembly 404 may be biohazardous after use, and can be disposed of appropriately. Opened support kit assembly 402 will contain unused reagent solutions, and used pipette tips. If biohazardous samples were processed, opened support kit assembly 402 will be biohazardous. Opened tray assembly 404 will contain used test strips 104, and used first disc assembly 109, second disc assembly 115, third disc assembly 121, and/or external vial 106. If biohazardous samples were processed, opened tray assembly 404 will be biohazardous. Disposal of biohazardous components is made easier by containment in opened tray assembly 404 and opened tray assembly 404. Even though many components are present, the user only needs to handle two components, opened support kit assembly 402 and opened tray assembly 404.

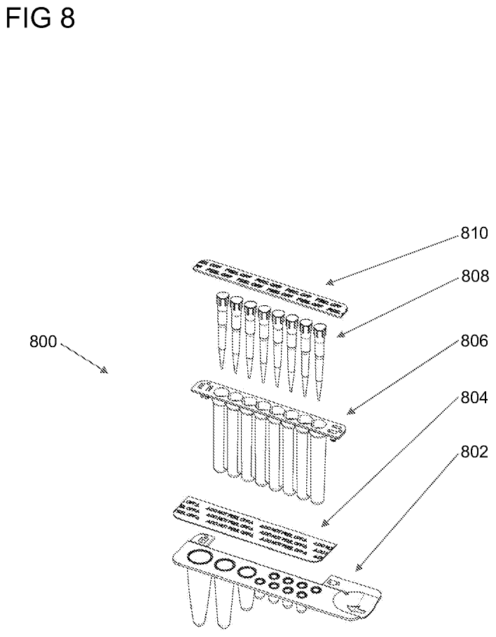

FIG. 8 is an exploded view illustrating an exemplary support pack assembly 800 in accordance with some embodiments of the present disclosure. In some embodiments, support pack assembly 800 includes reagent pack 802, reagent pack seal 804, tip pack 806, pipette tips 808, and tip pack seal 810. Reagent pack 802 is described in more detail in subsequent drawings, and in some embodiments, is injection molded in a polyolefin or similar material. It includes various reagent wells. In some embodiments, it also includes ribs for sealing, various alignment features, snaps or any combination thereof. Reagent pack seal 804 is a puncturable sealing film, which provides a hermetic seal around the reagent wells, and can be punctured by the instrument when needed. Tip pack 806 is also injection molded using a polyolefin or similar material, and provides a housing for pipette tips 808. Pipette tips 808 can be removed from tip pack 806 by the instrument, as needed. Tip pack seal 810 provides a temporary cover, preventing removal of pipette tips 808 from tip pack 806, until needed. Tip pack seal 810 is typically removed from tip pack 806 prior to inserting support pack assembly 800 into the instrument.

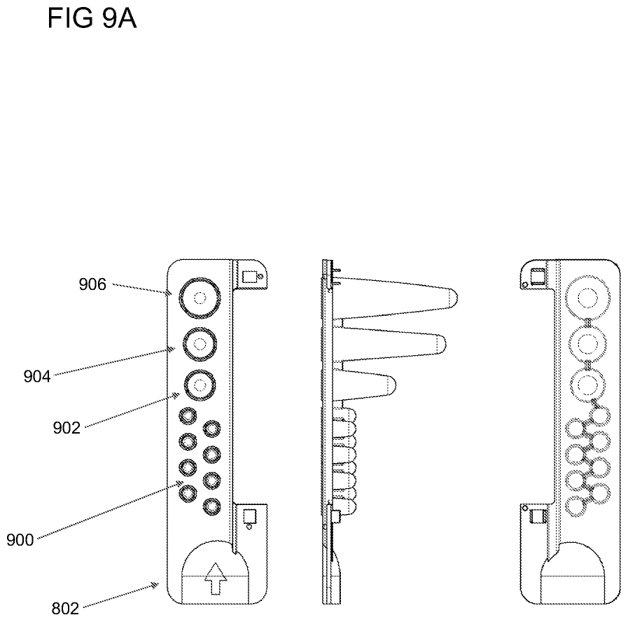

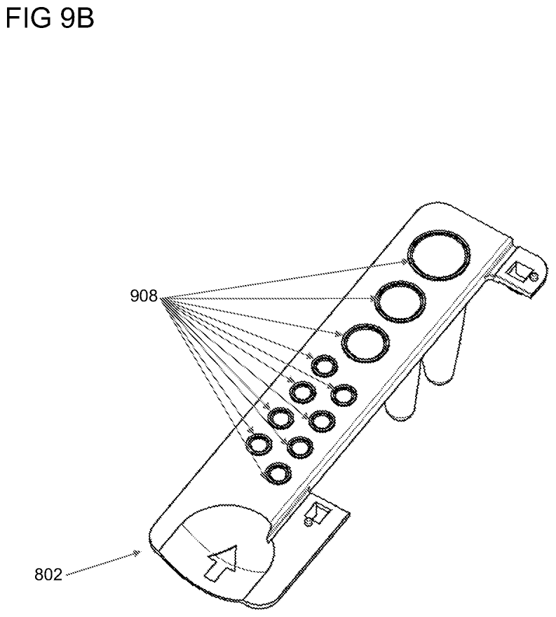

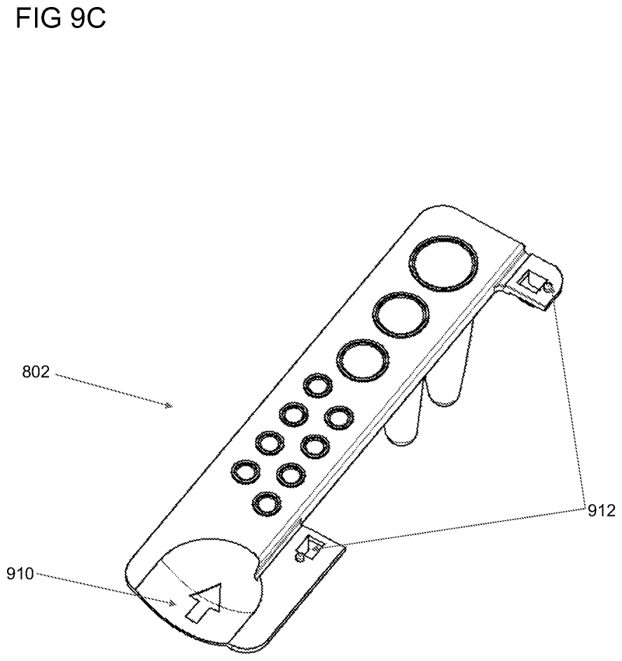

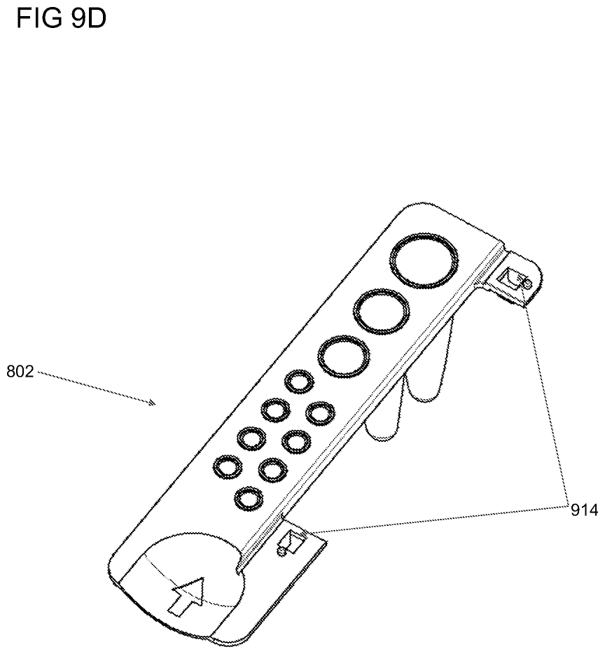

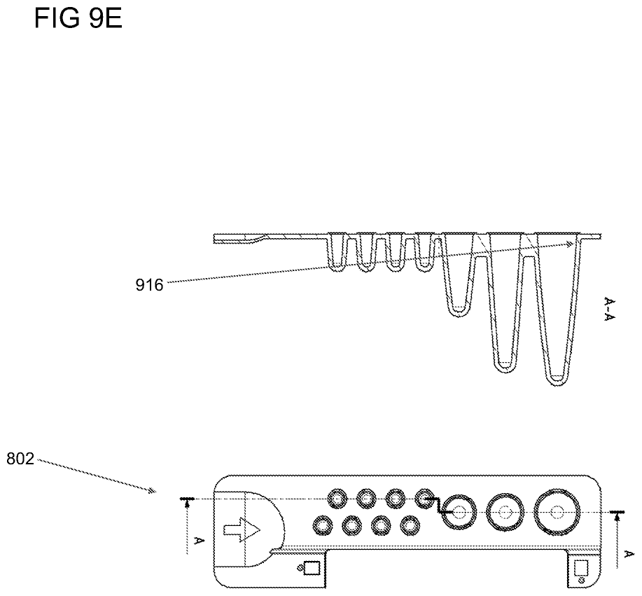

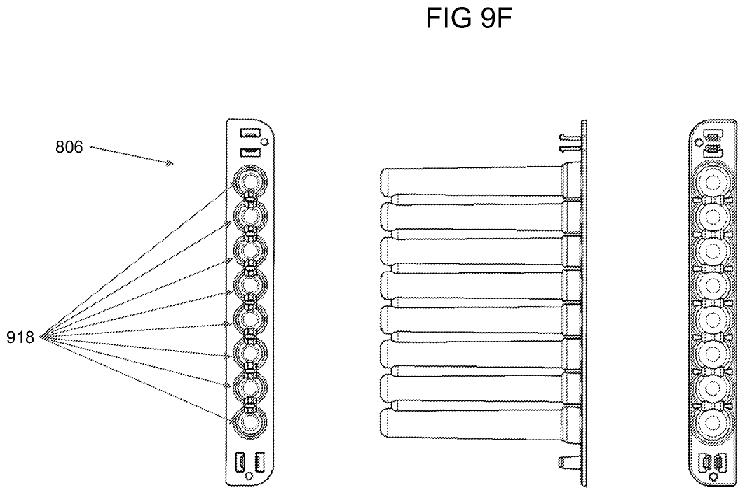

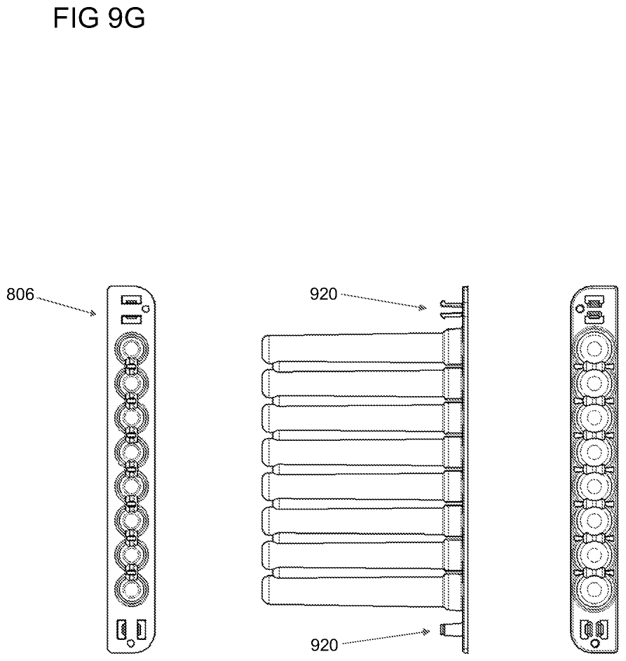

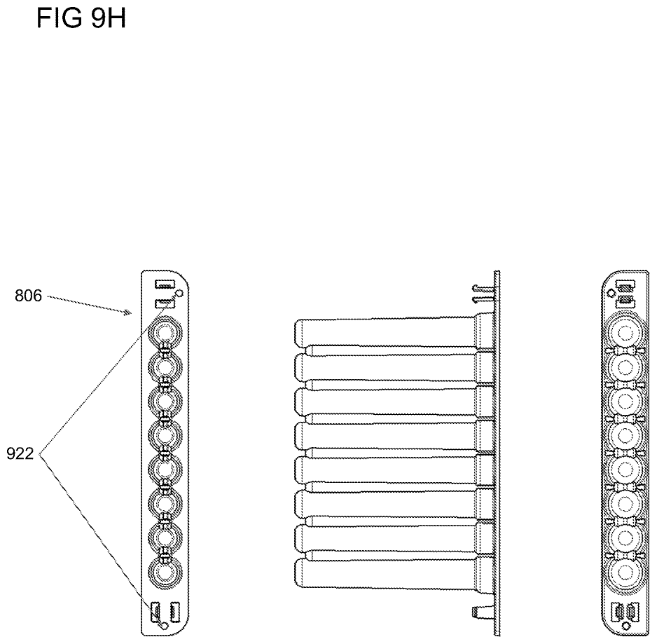

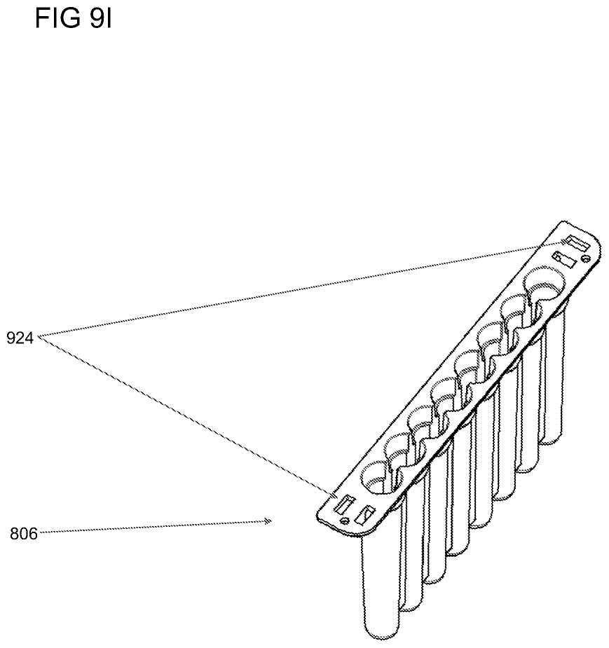

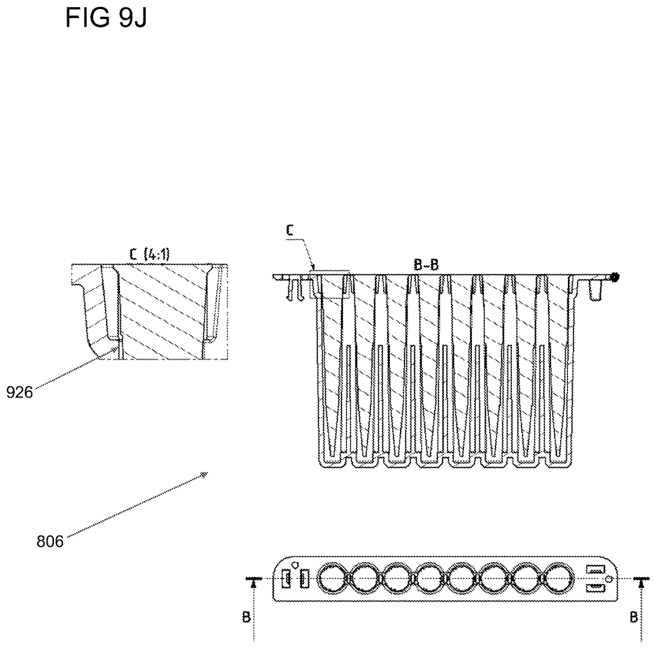

FIG. 9A illustrates reagent pack 802 in accordance with some embodiments of the present disclosure. In some embodiments, reagent pack 802 includes first reagent wells 900, at least one second reagent well 902, at least one third reagent well 904, at least fourth reagent well 906, or any combination thereof. First reagent wells 900 are the smallest in volume, while second reagent well 902, third reagent well 904, and fourth reagent well 906 are increasing in volume, depending on the requirements of support pack assembly 800. The number and size of reagent wells can vary in different embodiments, and the geometry illustrated in FIG. 9A is a non-limiting example. During manufacturing, reagent wells are filled with liquid reagents, which are used by the instrument at various points in the assay.

FIG. 9B illustrates some additional or optional features of reagent pack 802 in accordance with some embodiments of the present disclosure. In some embodiments, there are sealing ribs 908 around each of the reagent wells. Sealing ribs 908 provide a specific area around each reagent well where heat sealing of reagent pack seal 804 can occur, providing a hermetic seal for each reagent well.

FIG. 9C illustrates some additional or optional features of reagent pack 802 in accordance with some embodiments of the present disclosure. In some embodiments, reagent pack 802 includes thumb grip 910 and/or one or more locating pins 912. Thumb grip 910 provides a recess where users can grip reagent pack 802 while inserting and removing it from the instrument. One or more locating pins 912 provide a means for aligning reagent pack 802 while it is fastened to tip pack 806. One or more locating pins 912 provide precise positioning of reagent pack 802 relative to tip pack 806.

FIG. 9D illustrates some additional or optional features of reagent pack 802 in accordance with some embodiments of the present disclosure. In some embodiments, reagent pack 802 includes one or more snap feature cutouts 914. One or more snap feature cutouts 914 provide a means for attaching reagent pack 802 to tip pack 806. One or more snap feature cutouts 914 provides precise positioning of reagent pack 802 relative to tip pack 806, and prevent them from becoming disengaged.

FIG. 9E illustrates some additional or optional features of reagent pack 802 in accordance with some embodiments of the present disclosure. Cross sectional view A-A illustrates the geometry of various reagent wells. As illustrated in section A-A, a reagent well includes an opening, a closed bottom and a circumferential side wall between the opening and closed bottom. The circumferential side wall has variable draft angle 916 relative to an axis of the reagent well. In some embodiments, a reagent well is formed in a pre-defined profile such that draft angle 916 increases from the opening to the closed bottom of the reagent well. Variable draft angle 916 assists in injection molding of reagent pack 802, and can also help in filling, storage, and removal of reagent from reagent wells. Variable draft angle 916 can help in minimizing unwanted bubbles in the reagent wells.

In some embodiments, reagent pack 802 includes a plurality of wells. In some embodiments, the plurality of wells includes at least two wells with substantially the same pre-defined profile. In some embodiments, the plurality of wells includes at least two wells with different pre-defined profiles. In some embodiments, the plurality of wells includes a plurality sets of wells, each set including one or more wells. In some embodiments, an inner surface of each well in the plurality of wells is polished to reduce bubbling during transportation.

FIG. 9F illustrates an exemplary tip pack 806 in top, side, and bottom views in accordance with some embodiments of the present disclosure. In some embodiments, tip pack 806 includes various pipette tip nests 918, each of which can house a pipette tip. Pipette tips are loaded into tip pack 806 during manufacturing, can be removed by the instrument during an assay, and can be returned to tip pack 806 after use for disposal.

FIG. 9G illustrates some additional or optional features of tip pack 806 in top, side, and bottom views in accordance with some embodiments of the present disclosure. In some embodiments, tip pack 806 includes one or more snap features 920, which are used to attach tip pack 806 to reagent pack 802 during manufacturing. One or more snap features 920 provide precise positioning of tip pack 806 and reagent pack 802, which is important when inserting support pack assembly 800 into the instrument.

FIG. 9H illustrates some additional or optional features of tip pack 806 in top, side, and bottom views in accordance with some embodiments of the present disclosure. In some embodiments, tip pack 806 includes one or more tip pack locating holes 922, which engage with one or more locating pins 912 on reagent pack 802, ensuring precise positioning between tip pack 806 and reagent pack 802. Precise positioning is important as the instrument picks up and discards pipette tips, picks up and discards reagents, and interacts with support pack assembly 800.

FIG. 9I illustrates some additional or optional of tip pack 806 in accordance with some embodiments of the present disclosure. In some embodiments, tip pack 806 includes one or more tip pack cutouts 924, which engage with one or more snap feature cutouts 914 on reagent pack 802, ensuring precise positioning between tip pack 806 and reagent pack 802. As mentioned previously, precise positioning is important as the instrument picks up and discards pipette tips, picks up and discards reagents, and interacts with support pack assembly 800.

FIG. 9J illustrates some additional or optional features of tip pack 806 in top, side, and detail views in accordance with some embodiments of the present disclosure. In some embodiments, tip pack 806 includes tip interface 926. Tip interface 926 provides precise positioning of pipette tips in the instrument, while leaving the pipette tips free to be removed from and placed back into tip pack 806. Precise positioning of pipette tips is particularly important when being picked up by pipetting mechanisms in the instrument, and although the tips need move slightly as they are engaged by the instrument, movement should not be excessive.

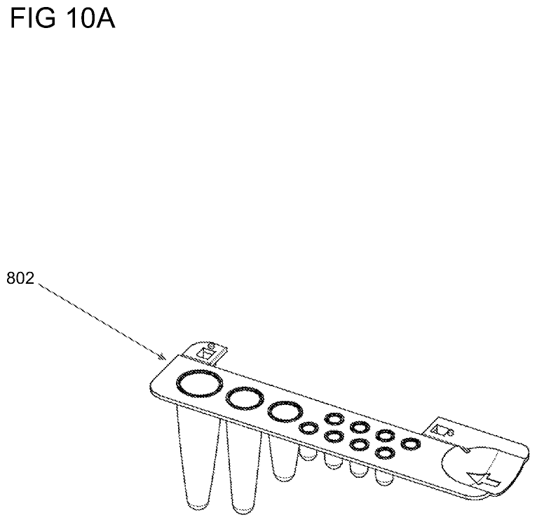

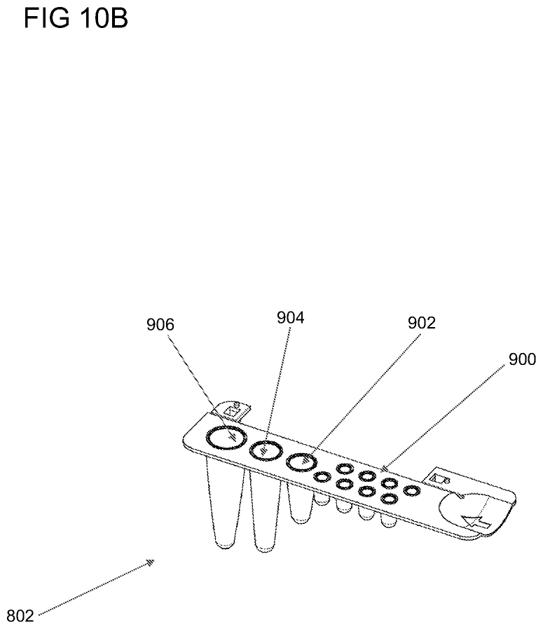

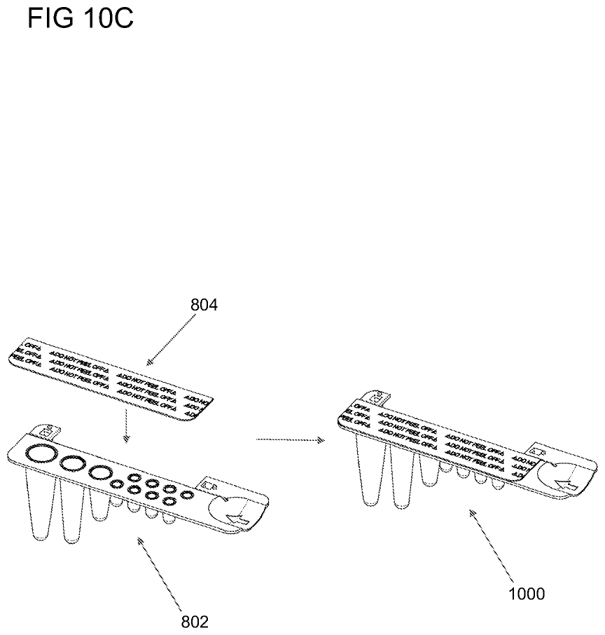

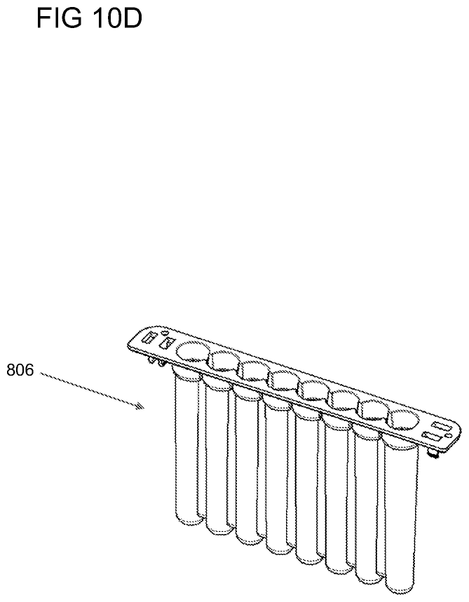

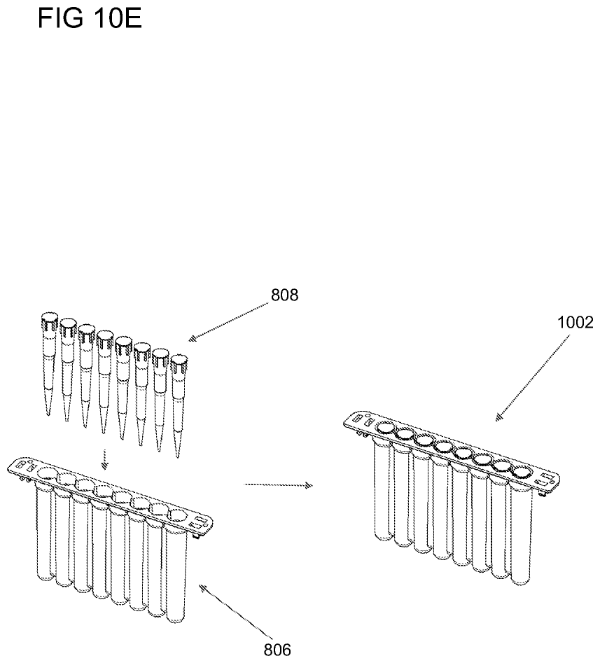

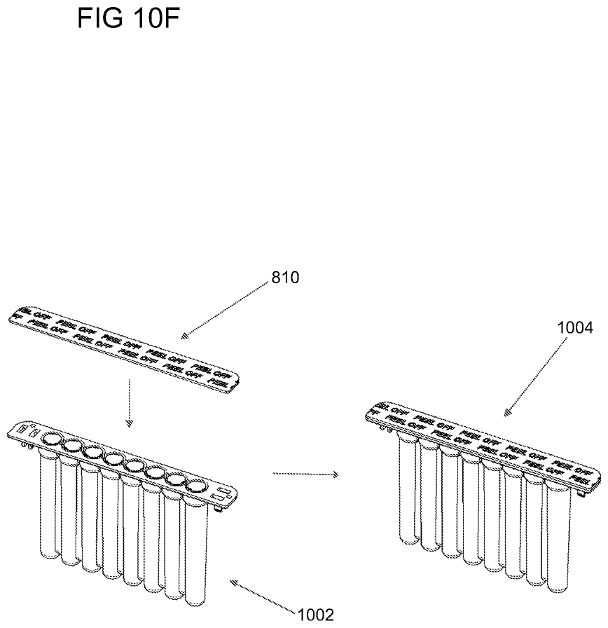

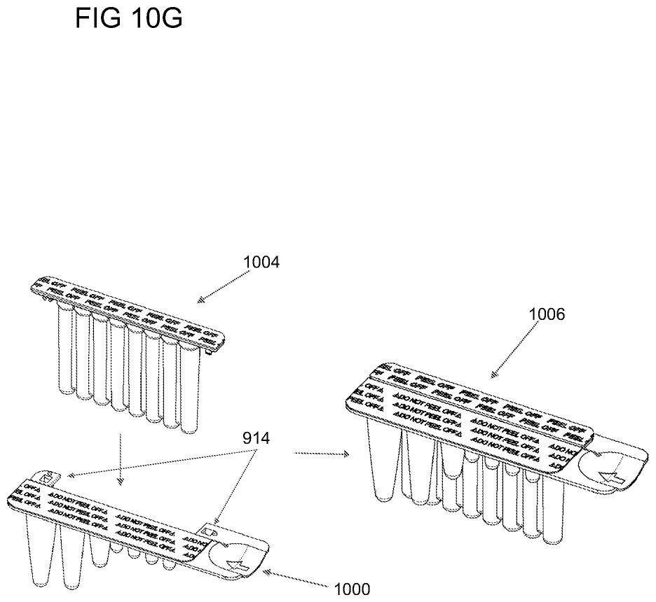

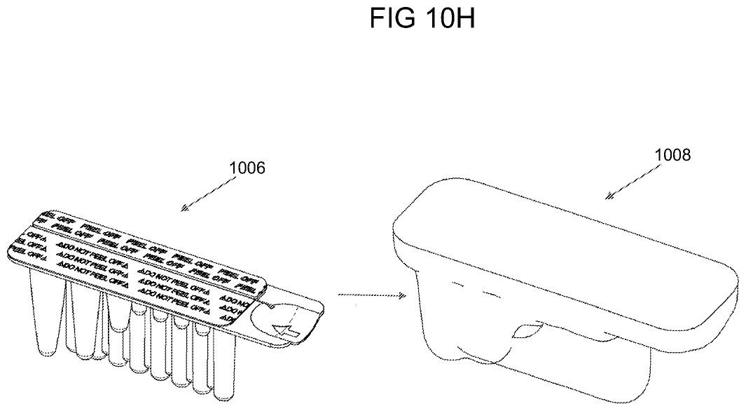

FIGS. 10A-10H illustrate assembly of an exemplary support pack in accordance with some embodiments of the present disclosure.

The assembly process starts with an empty reagent pack 802 as illustrated in FIG. 10A.

FIG. 10B illustrates reagent pack 802 in accordance with some embodiments of the present disclosure. In some embodiments, reagent pack 802 includes first reagent wells 900, second reagent well 902, third reagent well 904, and fourth reagent well 906. Reagent wells can be precisely filled with various liquid reagents.

As illustrated in FIG. 10C, after filling first reagent wells 900, second reagent well 902, third reagent well 904, and fourth reagent well 906 with reagents, reagent pack 802 is sealed with reagent pack seal 804, resulting in sealed reagent pack 1000. As mentioned previously, reagent pack seal 804 is sealed onto reagent pack 802 using heat sealing, although in alternative embodiments reagent pack seal 804 can be sealed to reagent pack 802 using adhesive or induction sealing. It is important that reagent pack seal 804 is thoroughly bonded to reagent pack 802, to prevent leakage or cross contamination of reagents.

FIG. 10D illustrates an empty tip pack 806. In preferred embodiments, tip pack 806 is injection molded using polyolefin or similar material.

In FIG. 10E, pipette tips 808 are inserted into tip pack 806, resulting in filled tip pack 1002. Although pipette tips 808 are positioned precisely in tip pack 806, they are free to be removed, then replaced, by the instrument. As mentioned previously, in preferred embodiments pipette tips 808 are injection molded using polyolefin or similar material.

In FIG. 10F, tip pack seal 810 is sealed onto filled tip pack 1002, resulting in sealed tip pack 1004. Tip pack seal 810 protects pipette tips 808 from debris, and prevents them from falling out of tip pack 806 during shipping. As the barrier properties of tip pack seal 810 are not critical, and it does not need to be punctured by the instrument, a wide variety of materials can be used for tip pack seal 810. Tip pack seal 810 can be attached to filled tip pack 1002 using heat sealing, adhesive bonding, or induction sealing, among other means.

In FIG. 10G, sealed tip pack 1004 is attached to sealed reagent pack 1000 by way of snap feature cutouts 914 and snap features 920 (illustrated in FIG. 9G), resulting in sealed support pack 1006. When it's time to insert the support pack into the instrument, reagent pack seal 804 and tip pack seal 810 can be removed before insertion.

In FIG. 10H, sealed support pack 1006 is packaged in support pack pouch 1008, for storage. Support pack pouch 1008 can be made out of a variety of materials, with materials that have low moisture vapor transmission rates being particularly desirable. Such materials would minimize evaporation of liquid from sealed support pack 1006 during long term storage.

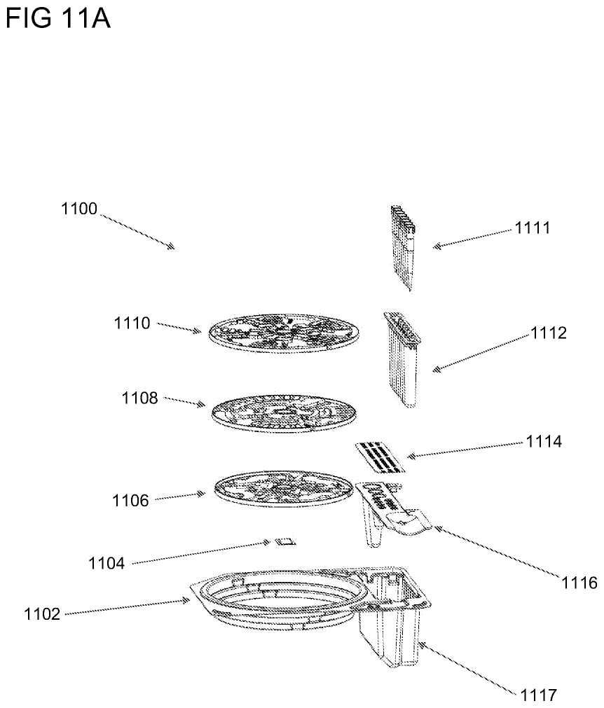

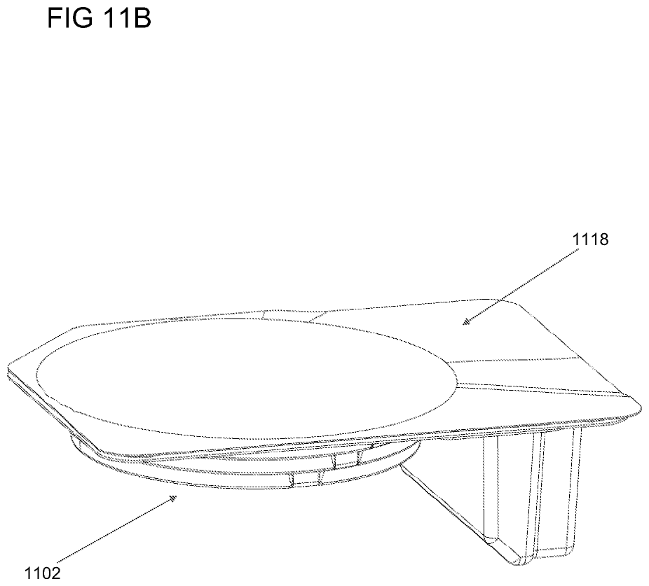

FIG. 11A illustrates an exemplary integrated kit 1100 in accordance with some embodiments of the present disclosure. In some embodiments, tray 1102 contains desiccant 1104, first disc assembly 1106, second disc assembly 1108, third disc assembly 1110, pipette tips 1111, tip pack 1112, reagent pack seal 1114, reagent pack 1116, or any combination thereof. In some embodiments, the space and/or feature on tray 1102 for accommodating pipette tips 1111, tip pack 1112, reagent pack seal 1114, reagent pack 1116 or any combination thereof is referred herein as a fourth compartment 1117. Instead of inserting opened support kit assembly 402, and opened tray assembly 404 into instrument drawer 400 (as illustrated in FIGS. 4A and 4B), integrated kit 1100 is inserted into the instrument instead.

As illustrated in FIG. 11B, when manufacturing integrated kit 1100, tray sealing film 1118 can be sealed onto tray 1102. Tray sealing film 1118 protects the contents of integrated kit 1100 from contamination, and can be removed before insertion of integrated kit 1100 into the instrument.

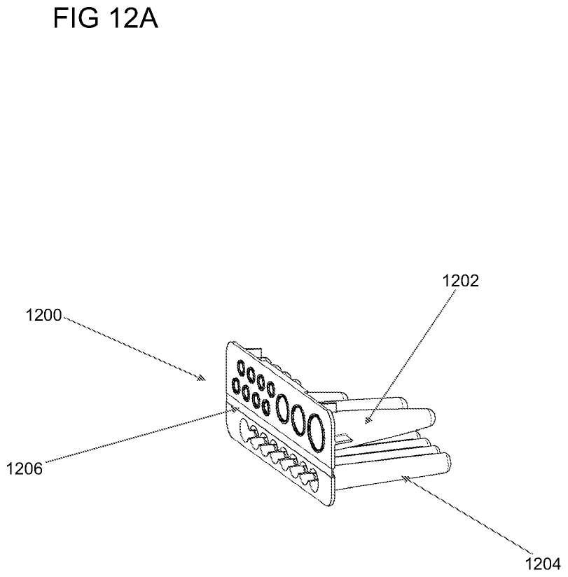

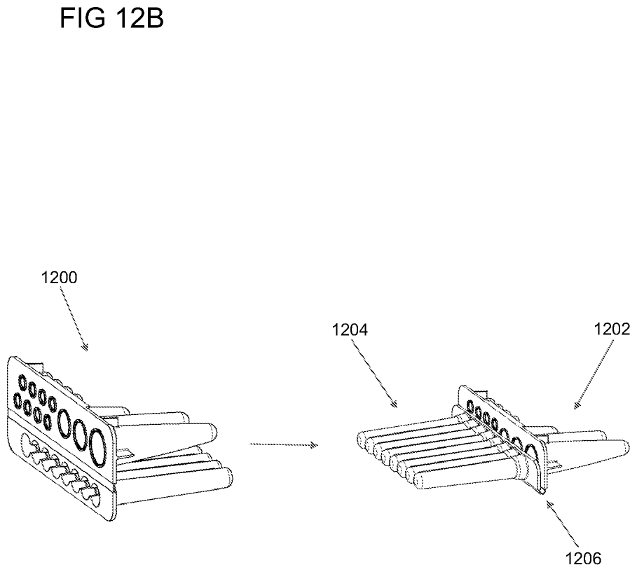

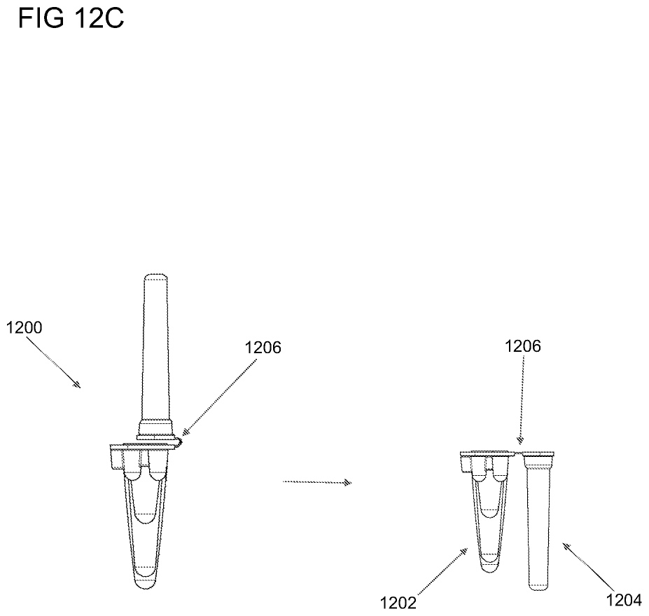

FIG. 12A illustrates an alternative embodiment of a support pack in accordance with some embodiments of the present disclosure. In some embodiments, unibody support pack 1200 includes a reagent pack portion 1202, a tip pack portion 1204, and an integrated hinge 1206. Instead of having separate reagent and tip packs which are connected during manufacturing, as illustrated in previous figures, unibody support pack 1200 features reagent and tip packs which are connected during the molding process, and hence feature a unibody construction. Reagent pack portion 1202 and tip pack portion 1204 are connected during injection molding by integrated hinge 1206. As illustrated in FIG. 12B, reagent pack portion 1202 and tip pack portion 1204 can be pivoted about the axis created by integrated hinge 1206, providing a lower profile assembly which has a lower profile for subsequent packaging operations. As described in previous embodiments, reagent pack portion 1202 can be filled with liquid reagents and sealed with foil during manufacturing, while tip pack portion 1204 can be filled with pipette tips and sealed with a removable film. Integrated hinge 1206 is typically left uncovered with foil or film.

FIG. 12B illustrates unibody support pack 1200 in both unfolded and folded states. After filling reagent pack portion 1202 with liquid reagents and sealing with foil, and after placing pipette tips into tip pack portion 1204 and sealing with film, unibody support pack 1200 is folded along integrated hinge 1206, as illustrated in FIG. 12B. In the folded state, unibody support pack 1200 has a lower profile, which could be advantageous for packaging and shipping.

Before use, unibody support pack 1200 is removed from its packaging (not shown) and unfolded, as illustrated in FIG. 12C. In an unfolded state, sealing film is removed from tip pack portion 1204, and unibody support pack 1200 can be inserted into the instrument for further processing.

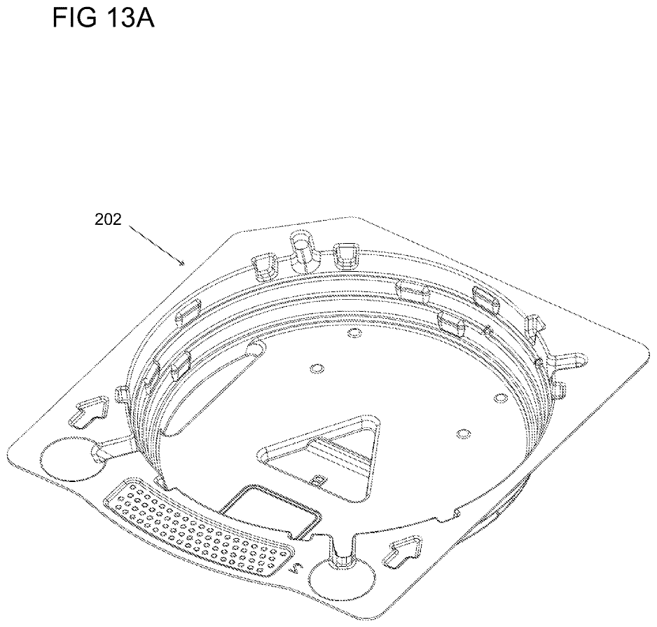

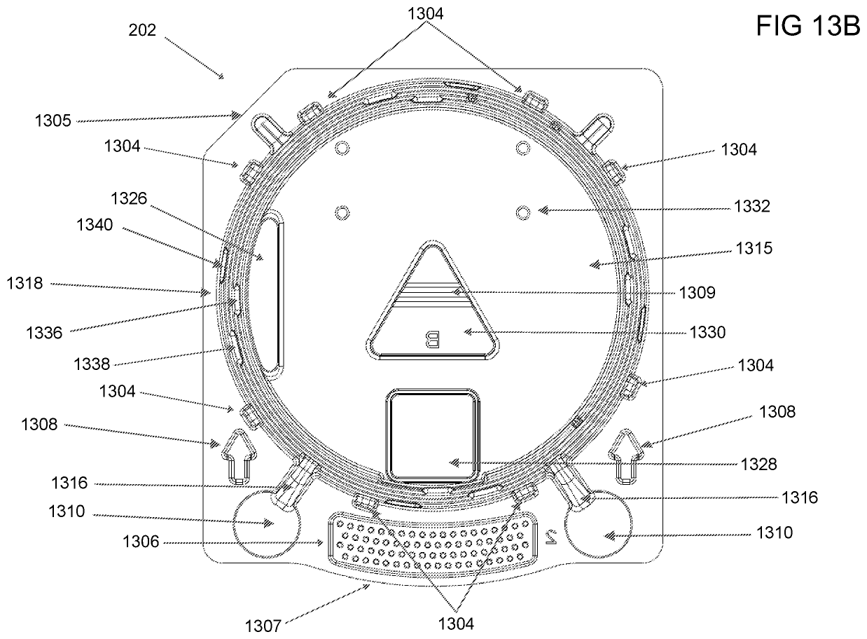

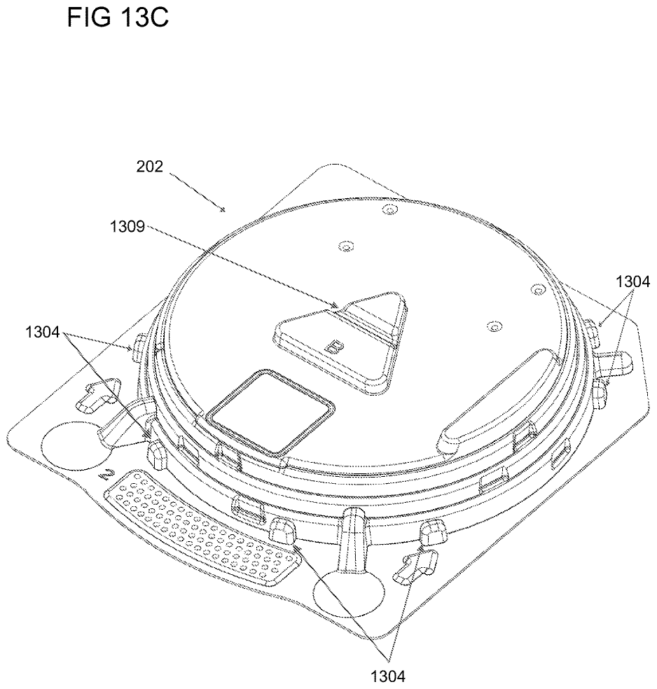

FIG. 13A-13C illustrate a second embodiment of the tray, generally designated 202, in accordance with some aspects of the present disclosure. Tray 202 is similar to the first embodiment of tray 102 except that, tray 202 includes stacking features 1304, a knurled surface 1306, a curved edge 1307, and ribs 1309 on the central positioning feature. The one or more stacking features 1304 can be added at various locations on the tray to protect the tray when stacked during transportation. The knurled surface 1306 and the curved edge 1307 provide better grip and improved comfort for the user during tray placement into the instrument and pick up.

Ribs 1309 serve as structural support for the central positioning feature and engage with a sensor button on the instrument to alert the instrument that a tray has been placed.

FIG. 14 illustrates a third embodiment of the tray, generally designated tray 302, in accordance with some aspects of the present disclosure. Tray 302 is similar to the second embodiment of tray 202 except that tray 302 has a straight edge 1404.

The devices and methods disclosed herein can be used in a variety of applications including but not limited to clinical chemistry, immunoassays and hematology. Examples of clinical chemistry, immunoassays and/or hematology are disclosed in WO2018/119437, WO2018/140719, WO2022/029731, and WO2022/029732, the content of each application is hereby incorporated by reference in its entirety. The devices and methods disclosed herein may be operated or performed by a system similar to those disclosed in U.S. patent application Ser. No. 17/371,746, the content of which is hereby incorporated by reference in its entirety.

Some embodiments or implementations are described with respect to the following clauses:
Clause A1. A tray comprising:
   a first compartment configured for stacking a plurality of disc assemblies, wherein the first compartment is substantially circular and comprises:
      (i) a stepped support comprising a plurality of steps along an axial direction of the first compartment and configured for accommodating a corresponding disc assembly in the plurality of disc assemblies that is characterized by a corresponding diameter in a plurality of diameters;
      (iii) at least one axial retaining member formed at or adjacent to each respective step in the plurality of steps and configured for preventing the corresponding disc assembly in the plurality of disc assemblies from moving in the axial direction when the corresponding disc assembly in the plurality of disc assemblies is placed in the first compartment; and
      (iv) at least one angular retaining member formed at or adjacent to each respective step in the plurality of steps and configured for preventing the corresponding disc assembly in the plurality of disc assemblies from rotating around an axis of the first compartment when the corresponding disc assembly in the plurality of disc assemblies is placed in the first compartment.
Clause A2. The tray of clause A1, wherein the plurality of steps is configured such that adjacent disc assemblies in the plurality of disc assemblies are spaced apart from each other along the axial direction of the first compartment when they are placed in the first compartment.
Clause A3. The tray of any preceding clause, wherein the plurality of steps comprises two, three, four, five or more steps.
Clause A4. The tray of any preceding clause, wherein the plurality of steps comprises:
   a first step at a first level, and configured for accommodating a first disc assembly; and
   a second step at a second level higher than the first level, and configured for accommodating a second disc assembly larger than the first disc assembly.
Clause A5. The tray of clause A4, wherein the plurality of steps comprises:
   a third step at a third level higher than the second level, and configured for accommodating a third disc assembly larger than the second disc assembly.
Clause A6. The tray of any preceding clause, wherein the plurality of disc assemblies comprises:
   a disc assembly configured for conducting a hematology test;
   a disc assembly configured for conducting a clinical chemistry test;
   a disc assembly configured for conducting an immunochemistry test; or
   any combination thereof.
Clause A7. The tray of clause A6, wherein the disc assembly configured for conducting the immunochemistry test is larger than the disc assembly configured for conducting the clinical chemistry test, which is larger than the disc assembly configured for conducting the hematology test.
Clause A8. The tray of any preceding clause, wherein the at least one axial retaining members formed at or adjacent to different steps in the plurality of steps are circumferentially staggered with respect to each other.
Clause A9. The tray of any preceding clause, wherein the at least one axial retaining member formed at each respective step in the plurality of steps comprises two, three, four or more axial retaining members circumferentially spaced apart from each other.
Clause A10. The tray of any preceding clause, wherein each of the at least one angular retaining member formed at or adjacent to each respective step in the plurality of steps is configured to engage with a notch formed at an outer perimeter of the corresponding disc assembly in the plurality of disc assemblies.
Clause A11. The tray of any preceding clause, wherein the at least one angular retaining member formed at or adjacent to each respective step in the plurality of steps consists of a single angular retaining member.
Clause A12. The tray of any preceding clause, wherein the first compartment further comprises:
   a bottom wall; and
   a central positioning feature formed at the bottom wall of the first compartment and configured for engaging with a locating feature of an instrument to prevent lateral and angular movement of the tray when the tray is placed in the instrument.
Clause A13. The tray of clause A12, wherein the central positioning feature has a cross section of a substantially triangular shape.
Clause A14. The tray of any one of clause A12-A13, wherein a support feature is formed at the bottom wall of the first compartment and leveled with the central positioning feature and a bottom wall of a second compartment to facilitate placement of the tray on a surface.
Clause A15. The tray of any one of clause A12-A14, wherein the first compartment comprises a designated area on an inner surface of the bottom wall for placing one or more test strips.
Clause A16. The tray of any preceding clause, further comprising:
   a second compartment configured for accommodating a desiccant; and
   a conduit connecting the second compartment with the first compartment.
Clause A17. The tray of any preceding clause, further comprising:
   a third compartment configured for accommodating a vial for one or more external processes from the plurality of disc assemblies.
Clause A18. The tray of any preceding clause, further comprising:
   a flange formed with the first compartment, the second compartment, and/or the third compartment and configured for engaging with a rail of an instrument.
Clause A19. The tray of clause A18, wherein the flange comprises a chamfered edge to prevent misplacement of the flange in the instrument.
Clause A20. The tray of any one of clause A18-A19, further comprising:
   a plurality of sealing ribs formed at an upper surface of the flange and configured for engaging with a sealing film;
   at least one gripping member formed at the flange and configured for facilitating easy grip of the tray;
   a plurality of structural ribs formed at the flange and/or the stepped support of the first compartment, and configured for enhancing a strength of the tray;
   at least one guiding member formed at the flange and configured for indicating a proper orientation of the tray;
   a feedback member formed at the flange and configured for providing a feedback regarding placement of the tray;
   a fourth compartment for accommodating a reagent pack, a pipette pack or both; or
   any combination thereof.
Clause B1. A tray assembly comprising:
   the tray of any preceding claim;
   at least one disc assembly placed in the first compartment of the tray; and
   a sealing film engaged with the tray to seal the at least one disc assembly in the first compartment of the tray.
Clause B2. The tray assembly of clause B1, wherein the at least one disc assembly comprises two or more disc assemblies in the plurality of disc assemblies.
Clause B3. The tray assembly of clause B1, wherein the at least one disc assembly comprises each of the plurality of disc assemblies.
Clause B4. The tray assembly of any one of clauses B1-B3, further comprising:
   a desiccant placed in a second compartment of the tray;
   a vial placed in a third compartment of the tray;
   one or more test strips placed on a bottom wall of the first compartment of the tray; or
   any combination thereof.
Clause C1. A method for making a tray assembly, comprising:
   A) obtaining the tray of any one of clauses A1-A20;
   B) placing, optionally, one or more test strips on the bottom wall of the first compartment of the tray;
   C) placing, optionally, a vial into a third compartment of the tray;
   D) placing, optionally, a desiccant into a second compartment of the tray;
   E) placing at least one disc assembly into the first compartment of the tray;
   F) sealing the first compartment, the second compartment, and/or the third compartment using a sealing film that engages with the tray;
   G) adding, optionally, a code and/or a logo to the tray; and
   H) placing, optionally, the tray in a pouch.
Clause C2. The method of clause C1, wherein the placing E) comprises placing two or more disc assemblies into the first compartment of the tray.
Clause C3. £ The method of clause C1 wherein the placing E) comprises placing each of the plurality of disc assemblies into the first compartment of the tray.
Clause D1. A tray assembly comprising:
   a plurality of disc assemblies, each characterized by a corresponding diameter in a plurality of diameters; and
   a tray comprising a first compartment configured for stacking the plurality of disc assemblies, wherein the first compartment is substantially circular and comprises a stepped support, and the stepped support comprises a plurality of steps along an axial direction of the first compartment, each configured for accommodating a corresponding disc assembly in the plurality of disc assemblies.
Clause E1. A tray assembly comprising:
   at least one disc assembly, each comprising a notch formed at an outer perimeter of the disc assembly; and
   a tray comprising a first compartment configured for accommodating the at least one disc assembly, wherein the first compartment is substantially circular and comprises a circumferential side wall, and the circumferential side wall of the first compartment comprises at least one angular retaining member, each engaged with the notch of a corresponding disc assembly in the at least one disc assembly to prevent the corresponding disc assembly from rotating around an axis of the first compartment.
Clause E2. The tray assembly of clause E1, wherein the at least one disc assembly consists of a single disc assembly.
Clause E3. The tray assembly of clause E1, wherein the at least one disc assembly comprises two or more disc assemblies.
Clause E4. The tray assembly of any one of clauses D1-E3, wherein the tray further comprises:
   a second compartment configured for accommodating a desiccant;
   a conduit connecting the second compartment with the first compartment;
   a third compartment configured for accommodating a vial for one or more external processes;
   a fourth compartment configured for accommodating a support pack assembly; or
   any combination thereof.
Clause E5. The tray assembly of clause E4, further comprising:
   a desiccant disposed in the second compartment;
   a vial disposed in the third compartment and configured for one or more external processes from the plurality of disc assemblies;
   a support pack assembly disposed in the fourth compartment; or
   any combination thereof.
Clause F1. A reagent pack comprising:
   a plurality of wells, each respective well in the plurality of wells comprising:
      a corresponding opening;
      a corresponding closed bottom; and
      a corresponding circumferential side wall between the corresponding opening and closed bottom and formed in a corresponding pre-defined profile, wherein an angle of the corresponding pre-defined profile relative to an axis of the respective well increases from the corresponding opening to the corresponding closed bottom of the respective well.
Clause F2. The reagent pack of clause F1, wherein the corresponding pre-defined profile is configured to assist in injection molding of the reagent pack, in filling, storage, and removal of reagent from the respective well, in minimizing unwanted bubbles in the respective well, or any combination thereof.
Clause F3. The reagent pack of any one of clauses F1-F2, wherein the plurality of wells comprises at least two wells with substantially the same pre-defined profile.
Clause F4. The reagent pack of any one of clauses F1-F3, wherein the plurality of wells comprises at least two wells with different pre-defined profiles.
Clause F5. The reagent pack of any one of clauses F1-F4, wherein the plurality of wells comprises a plurality sets of wells, each set comprising one or more wells.
Clause F6. The reagent pack of any one of clauses F1-F5, wherein an inner surface of each well in the plurality of wells is polished to reduce bubbling during transportation.
Clause F7. The reagent pack of any one of clauses F1-F6, further comprising:
   a plurality of ribs, each surrounding an opening of a well in the plurality of wells to facilitate seal of the well;
   at least one gripping member to facilitate easy grip of the reagent pack;
   at least one guiding member to indicate a proper orientation of the reagent pack;
   at least one engaging member to facilitate assembling with a tip pack; or
   any combination thereof.
Clause G1. A tip pack comprising:
   a plurality of pipette tip nests, each formed with a tip interface to allow a corresponding pipette tip in a plurality of pipette tips sit on the tip interface, thereby facilitating accurate pickup of the corresponding pipette tip with minimal movement.
Clause G2. The tip pack of clause G1, further comprising:
   at least one engaging member and/or at least one locating member to facilitate assembling with a reagent pack.
Clause H1. A support pack assembly comprising:
   the reagent pack of any one of clauses F1-F7 coupled with the tip pack of any one of clauses G1-G2.

### TERMINOLOGIES AND REFERENCES CITED

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will be understood that the terms “left” or “right”, “top” or “bottom”, “lower” or “upper”, “interior” or “exterior”, “inward” or “outward” and etc. are used to describe features of the exemplary embodiments with reference to the positions of such features as displayed in the figures. It will be understood that, although the terms “first,” “second,” etc. may be used herein to describe various elements, these elements should not be limited by these terms. These terms are only used to distinguish one element from another. For example, a first element could be termed a second element, and, similarly, a second element could be termed a first element, without changing the meaning of the description, so long as the “first element” and the “second element” are renamed consistently.

As used herein, the term “and/or” as used herein refers to and encompasses any and all possible combinations of one or more of the associated listed items. It will be further understood that the terms “include”, “includes”, “including”, “comprise”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “about” or “approximately” is used herein to provide literal support for the exact number that it precedes, as well as a number that is near to or approximately the number that the term precedes. In determining whether a number is near to or approximately a specifically recited number, the near or approximating unrecited number may be a number, which, in the context in which it is presented, provides the substantial equivalent of the specifically recited number. It should be appreciated that all numerical values and ranges disclosed herein are approximate values and ranges, whether “about” is used in conjunction therewith. It should also be appreciated that the term “about,” as used herein, in conjunction with a numeral refers to a value that may be ±0.01% (inclusive), ±0.1% (inclusive), ±0.5% (inclusive), ±1% (inclusive) of that numeral, ±2% (inclusive) of that numeral, ±3% (inclusive) of that numeral, ±5% (inclusive) of that numeral, ±10% (inclusive) of that numeral, or ±15% (inclusive) of that numeral. It should further be appreciated that when a numerical range is disclosed herein, any numerical value falling within the range is also specifically disclosed.

The term “if” used herein is, optionally, construed to mean “when” or “upon” or “in response to determining” or “in response to detecting” or “in accordance with a determination that,” depending on the context. Similarly, the phrase “if it is determined” or “if [a stated condition or event] is detected” used herein is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

When a reference number is given an “i^{th}” denotation, the reference number refers to a generic component, set, or embodiment. For instance, a “unit i” refers to the i^{th} unit in a plurality of units.

All references cited herein are incorporated herein by reference in their entirety and for all purposes to the same extent as if each individual publication or patent or patent application was specifically and individually indicated to be incorporated by reference in its entirety for all purposes.

What is claimed is:

1. A tray comprising:
a first compartment configured for stacking a plurality of disc assemblies, wherein the first compartment is substantially circular and comprises:
(i) a stepped support comprising a plurality of steps along an axial direction of the first compartment and configured for accommodating a corresponding disc assembly in the plurality of disc assemblies that is characterized by a corresponding diameter in a plurality of diameters;
(ii) at least one axial retaining member formed at or adjacent to each respective step in the plurality of steps and configured for preventing undesired movement of the corresponding disc assembly in the plurality of disc assemblies in the axial direction when the corresponding disc assembly in the plurality of disc assemblies is placed in the first compartment; and
(iii) at least one angular retaining member formed at or adjacent to each respective step in the plurality of steps and configured for preventing undesired rotation of the corresponding disc assembly in the plurality of disc assemblies around an axis of the first compartment when the corresponding disc assembly in the plurality of disc assemblies is placed in the first compartment.

2. The tray of claim 1, wherein the plurality of steps is configured such that adjacent disc assemblies in the plurality of disc assemblies are spaced apart from each other along the axial direction of the first compartment when they are placed in the first compartment.

3. The tray of claim 2, wherein the plurality of steps comprises two, three, four, five or more steps.

4. The tray of claim 3, wherein the plurality of steps comprises:
a first step at a first level, and configured for accommodating a first disc assembly; and
a second step at a second level higher than the first level, and configured for accommodating a second disc assembly larger than the first disc assembly.

5. The tray of claim 4, wherein the plurality of steps comprises:
a third step at a third level higher than the second level, and configured for accommodating a third disc assembly larger than the second disc assembly.

6. The tray of claim 1, wherein the plurality of disc assemblies comprises:
a disc assembly configured for conducting a hematology test;
a disc assembly configured for conducting a clinical chemistry test;
a disc assembly configured for conducting an immunochemistry test; or any combination thereof.

7. The tray of claim 6, wherein the disc assembly configured for conducting the immunochemistry test is larger than the disc assembly configured for conducting the clinical chemistry test, which is larger than the disc assembly configured for conducting the hematology test.

8. The tray of claim 1, wherein the at least one axial retaining members formed at or adjacent to different steps in the plurality of steps are circumferentially staggered with respect to each other.

9. The tray of claim 8, wherein the at least one axial retaining member formed at each respective step in the plurality of steps comprises two, three, four or more axial retaining members circumferentially spaced apart from each other.

10. The tray of claim 1, wherein each of the at least one angular retaining member formed at or adjacent to each respective step in the plurality of steps is configured to engage with a notch formed at an outer perimeter of the corresponding disc assembly in the plurality of disc assemblies.

11. The tray of claim 10, wherein the at least one angular retaining member formed at or adjacent to each respective step in the plurality of steps consists of a single angular retaining member.

12. The tray of claim 1, wherein the first compartment further comprises:
a bottom wall; and
a central positioning feature formed at the bottom wall of the first compartment and configured for engaging with a locating feature of an instrument to prevent lateral and angular movement of the tray when the tray is placed in the instrument.

13. The tray of claim 12, wherein the central positioning feature has a cross section of a substantially triangular shape.

14. The tray of claim 12, wherein a support feature is formed at the bottom wall of the first compartment and leveled with the central positioning feature and a bottom wall of a second compartment to facilitate placement of the tray on a surface.

15. The tray of claim 12, wherein the first compartment comprises a designated area on an inner surface of the bottom wall for placing one or more test strips.

16. The tray claim 1, further comprising:
a second compartment configured for accommodating a desiccant; and
a conduit connecting the second compartment with the first compartment.

17. The tray of claim 16, further comprising:
a third compartment configured for accommodating a vial for one or more external processes from the plurality of disc assemblies.

18. The tray of claim 17, further comprising:
a flange formed with the first compartment, the second compartment, and/or the third compartment and configured for engaging with a rail of an instrument.

19. The tray of claim 18, wherein the flange comprises a chamfered edge to prevent misplacement of the flange in the instrument.

20. The tray of claim 18, further comprising:
a plurality of sealing ribs formed at an upper surface of the flange and configured for engaging with a sealing film;
at least one gripping member formed at the flange and configured for facilitating easy grip of the tray;
a plurality of structural ribs formed at the flange and/or the stepped support of the first compartment, and configured for enhancing a strength of the tray;
at least one guiding member formed at the flange and configured for indicating a proper orientation of the tray;
a feedback member formed at the flange and configured for providing a feedback regarding placement of the tray;
a fourth compartment for accommodating a reagent pack, a pipette pack or both; or any combination thereof.

21. The tray of claim 20 further comprising:
the reagent pack comprising:
a plurality of wells, each respective well in the plurality of wells comprising:
a corresponding opening;
a corresponding closed bottom; and
a corresponding circumferential side wall between the corresponding opening and closed bottom and formed in a corresponding pre-defined profile, wherein an angle of the corresponding pre-defined profile relative to an axis of the respective well increases from the corresponding opening to the corresponding closed bottom of the respective well.

22. A tray comprising:
a first compartment configured for stacking a plurality of disc assemblies, wherein the first compartment is substantially circular and comprises:
(i) a stepped support comprising a plurality of steps along an axial direction of the first compartment and configured for accommodating a corresponding disc assembly in the plurality of disc assemblies that is characterized by a corresponding diameter in a plurality of diameters;
(ii) at least one axial retaining member formed at or adjacent to each respective step in the plurality of steps and configured for preventing the corresponding disc assembly in the plurality of disc assemblies from moving in the axial direction when the corresponding disc assembly in the plurality of disc assemblies is placed in the first compartment; and
(iii) at least one angular retaining member formed at or adjacent to each respective step in the plurality of steps and configured for preventing the corresponding disc assembly in the plurality of disc assemblies from rotating around an axis of the first compartment when the corresponding disc assembly in the plurality of disc assemblies is placed in the first compartment.
a second compartment configured for accommodating a desiccant;
a third compartment configured for accommodating a vial for one or more external processes from the plurality of disc assemblies;
a reagent pack comprising:
a plurality of wells, each respective well in the plurality of wells comprising:
a corresponding opening;
a corresponding closed bottom; and
a corresponding circumferential side wall between the corresponding opening and closed bottom and formed in a corresponding pre-defined profile, wherein an angle of the corresponding pre-defined profile relative to an axis of the respective well increases from the corresponding opening to the corresponding closed bottom of the respective well;
a fourth compartment for accommodating the reagent pack, a pipette pack or both; or any combination thereof; and
one or more test strips comprising reaction pads that perform colorimetric assays on samples such as urine, whole blood, plasma, serum, or other processed samples.
